(19) United States
(12) Patent Application Publication
(10) Pub. No.: US 2025/0070282 A1
(43) Pub. Date: Feb. 27, 2025

(54) INTELLIGENT BATTERY AND ASSEMBLY METHOD

(71) Applicant: CPS Technology Holdings LLC, New York, NY (US)

(72) Inventors: Jason D. FUHR, Sussex, WI (US); Tyler THIEL, Milwaukee, WI (US); Arunraj VARATHARAJAH, Menomonee Falls, WI (US); Rengaraj BALAKRISHNAN, Cary, NC (US); Gerardus C. ZWEGERS, Waterville, OH (US)

(21) Appl. No.: 18/726,337

(22) PCT Filed: Jan. 3, 2023
(86) PCT No.: PCT/US2023/060031

§ 371 Date: Jul. 2, 2024

Related U.S. Application Data
(60) Provisional application No. 63/339,822, filed on May 9, 2022.
(60) Provisional application No. 63/306,824, filed on Feb. 4, 2022.
(60) Provisional application No. 63/296,018, filed on Jan. 3, 2022.

(51) Int. Cl. H01M 10/42; B60L 50/64; B60L 58/10; H01M 10/48; H01M 50/209; H01M 50/264; H01M 50/271; H01M 50/296; H01M 50/325; H01M 50/383; H01M 50/503; H01M 50/507; H01M 50/591

(52) U.S. Cl. CPC H01M 10/4257; B60L 50/64; B60L 58/10; H01M 10/482; H01M 10/486; H01M 50/209; H01M 50/264; H01M 50/271; H01M 50/296; H01M 50/325; H01M 50/383; H01M 50/503; H01M 50/507; H01M 50/591; H01M 2010/4271; H01M 2220/20

(57) ABSTRACT

A lead assembly of a battery comprising a plurality of battery cells is described. The lead assembly includes a plurality of leads. Each lead has a first end and a second end opposite to the first end. The first end includes a first connector, and the second end includes a second connector. The second connector of one or more leads is couplable to a corresponding battery cell of the plurality of battery cells. Further, the lead assembly includes a lead frame enclosing at least a portion of each of the leads of the plurality of leads.

### TECHNICAL FIELD

This disclosure relates to batteries and in particular to a smart battery to facilitate battery performance/failure monitoring and venting.

### BACKGROUND

As battery technology evolves, the demand for improved power sources such as energy storage modules for vehicles continues to grow. Existing battery systems, for example lead acid battery systems, typically offer limited access to performance and failure monitoring, and have complex venting arrangements. More specifically, existing lead acid battery systems may not be capable of providing one or more battery parameters (e.g., usable to determine performance and/or predict/monitor failure) of one or more battery cells of the lead acid battery system. In other words, it is difficult for existing lead acid battery systems to provide information about vital components, such as the state of health of the battery cells. Accordingly, the state of health of battery cells cannot be monitored and/or determined, thus hindering the ability to predict upcoming battery failure or the onset of failure. Also, complex venting arrangements are relied on to release pressure from individual battery cells.

### SUMMARY

Some embodiments advantageously provide a method and apparatus, e.g., smart battery. In some embodiments the apparatus includes element(s) connecting at least one lead to a corresponding battery cell. The lead(s) may be connected to a battery management system (BMS), e.g., to determine/measure at least one parameter, such as cell voltage, current, temperature, etc. In some embodiments, one lead is connected to a terminal of the battery and another lead is connected to one battery cell. In some other embodiments, more than one lead is connected to battery cells. In a nonlimiting example, the battery includes six leads, where each one of five leads is connected to one battery cell, and the sixth lead is connected to a positive terminal of the battery. However, the battery is not limited as such and may include any quantity of leads and/or each lead be connected to one or more components of the battery, e.g., battery cells.

In some other embodiments, connecting leads to battery cells includes connecting each lead to one post that is connected to one battery cell. In one embodiment, the post may be covered by a bushing and/or the lead is heated, e.g., to solder the lead, to connect the lead to the post. In another embodiment, the battery includes a first cover, a second cover, and/or a third cover. The second cover may include a valve, e.g., a pressure release valve, arranged to release a pressure from the case where all battery cells are housed. In some embodiments, only one valve is included in the battery, such as in a common space. In some other embodiments, more than one valve is included in the battery in the common space. The first cover may be coupled to a case of the battery. The second cover may be coupled to the first cover, and/or the third cover coupled to the second cover. In some embodiments, the leads are within cover space that is external to a case internal space.

According to one aspect, a lead assembly of a battery comprising a plurality of battery cells is described. The lead assembly comprises a plurality of leads. Each lead has a first end and a second end opposite to the first end. The first end comprises a first connector, and the second end comprises a second connector. The second connector of one or more leads is couplable to a corresponding battery cell of the plurality of battery cells. Further, the lead assembly comprises a lead frame enclosing at least a portion of each of the leads of the plurality of leads.

In some embodiments, the second connector comprises a lead ring.

In some other embodiments, the second connector further comprises a post connector coupled to the lead ring, where the post connector is couplable to one battery cell.

In an embodiment, the plurality of leads comprises one lead couplable to a terminal. The lead frame comprises a first portion, a second portion, and an adjustable arm coupled to the first and second portions, where the first portion comprises the one lead.

In another embodiment, the adjustable arm is arranged to adjust a position of the first portion, where the adjusted position causes the first portion and the second portion to be in different planes.

In some embodiments, the first end of each lead protrudes from the lead frame and is couplable to a battery management system.

According to another aspect, a battery is described. The battery comprises a plurality of posts; and a plurality of battery cells, where each battery cell of the plurality of battery cells is coupled to one post of the plurality of posts. a case housing the plurality of battery cells. The battery further comprises a first cover sealed to the case and comprising a first plurality of openings. Each opening of the first plurality of openings receives one post of the plurality of posts and couples the one post to the first cover. The battery also comprises a battery management system configured to determine one or more parameters associated with the battery; and a lead assembly comprising a plurality of leads. Each lead of the plurality of leads has a first end, a second end opposite to the first end. The first end comprises a first connector, and the second end comprises a second connector. The first connector of each lead is coupled to the battery management system, and the second connector of each lead is coupled to one post. Each lead of the plurality of leads establishes an electrical connection between one battery cell and the battery management system to determine the one or more parameters.

In some embodiments, the battery further comprises a plurality of straps, where each strap of the plurality of straps has a first side and a second side. The first side is coupled to one post of the plurality of posts, and the second side is coupled to one battery cell of the plurality of battery cells.

In some other embodiments, the first cover further comprises a plurality of bushings, where each bushing of the plurality of bushings is coupled to the first cover and one corresponding post.

In an embodiment, the battery further comprises a case internal space defined by the first cover, the case, and the coupling of each bushing to the first cover and to the one corresponding post.

In another embodiment, the coupling of the second connector further comprises coupling the second connector to one corresponding bushing, where the coupling of the second connector is external to the case internal space.

In some embodiments, the battery further comprises a second cover sealed to the first cover and defining a cover space between the first and second covers, where the first cover further comprises a second plurality of openings establishing fluid communication between the cover space and the case internal space.

In some other embodiments, the second cover comprises a valve arranged to release, from the case internal space and the cover space, fluid having a pressure at or greater than a predetermined pressure threshold.

In an embodiment, the second cover further comprises a flame arrestor plug in fluid communication with the valve, where the flame arrestor plug comprises a flame arrestor arranged to prevent a flame ignitable by the release of fluid by the valve.

In another embodiment, the battery further comprises a third cover, where the second cover includes an access opening and is coupled to the third cover to cover the access opening. The first, second, and third covers define an access space that is external to the cover space and comprises the battery management system and the lead assembly.

In some embodiments, the lead assembly further comprises a lead frame enclosing at least a portion of each of the leads of the plurality of leads.

In some other embodiments, the lead frame comprises a first portion, a second portion, and an adjustable arm coupled to the first and second portions.

In an embodiment, the adjustable arm is arranged to adjust a position of the first portion, where the adjusted position causes the first portion and the second portion to be in different planes.

In another embodiment, the battery comprises a first terminal, and the first portion is coupled to the first terminal and further establishes the electrical connection between the first terminal and the battery management system.

In some embodiments, the battery further comprises a vehicle connector electrically coupled to the battery management system.

In some other embodiments, the plurality of battery cells includes a first cell and a second cell. The one of more parameters determined by the battery management system includes one or both of a first voltage of the first cell and a second voltage of the second cell; and a first temperature of the first cell and a second temperature of the second cell. The first voltage, the second voltage, the first temperature, and the second temperature are determined using the established electrical connection.

In an embodiment, the battery management system is further configured to one or more of receive a vehicle parameter; determine the vehicle parameter based on the one or more parameters associated with the battery; cause transmission of the determined vehicle parameter; and cause transmission of the one or more parameters associated with the battery.

According to one aspect, an assembly method of a battery is described. The battery comprises a plurality of posts, a plurality of battery cells, a case, a first cover, a battery management system, and a lead assembly. Each battery cell of the plurality of battery cells is coupled to one post of the plurality of posts. The case houses the plurality of battery cells. The first cover comprises a first plurality of openings. The lead assembly comprises a plurality of leads. Each lead comprises a first connector and a second connector. The method comprises inserting each post of the plurality of posts through a corresponding opening of the first plurality of openings; coupling the first cover to the case; and coupling the first connector of each lead to the battery management system and the second connector of each lead to a corresponding post of the plurality of posts. Each lead of the plurality of leads establishes an electrical connection between one battery cell and the battery management system to determine one or more parameters associated with the battery.

In some embodiments, the first cover further comprises a plurality of bushings, and the method further comprises coupling each bushing of the plurality of bushings to a corresponding opening of the first plurality of openings. The inserting of each post of the plurality of posts through the corresponding opening comprises inserting each post of the plurality of posts through a corresponding bushing; and coupling each posts of the plurality of posts to the corresponding bushing.

In some other embodiments, the inserting of each post of the plurality of posts through the corresponding opening and coupling the first cover to the case create a case internal space defined by the first cover, the case, each bushing, and each post. The coupling of the second connector of each lead to the corresponding post is external to the case internal space.

In an embodiment, the first cover further comprises a second plurality of openings and a second cover. The second cover comprises a cover space. The method comprises coupling the second cover to the first cover, the coupling of the second cover establishing fluid communication between the cover space and the case internal space through the second plurality of openings.

In another embodiment, the second cover comprises a valve and a flame arrestor plug, and the method comprises coupling the valve to the second cover, where the valve is in fluid communication with the cover space; and coupling the flame arrestor plug to the second cover. The flame arrestor plug is in fluid communication with the valve.

In some embodiments, the second cover further comprises a vehicle connector, and the method further comprises electrically coupling the vehicle connector to the battery management system.

In some other embodiments, the battery further comprises a third cover, the second cover comprises an access opening, and the method further comprises coupling the third cover the second cover to cover the access opening. The first, second, and third covers define an access space, where the access space is external to the cover space and comprises the battery management system and the lead assembly.

In an embodiment, the battery comprises a first terminal and a second terminal, and the method further comprises coupling the first terminal to the first connector of one lead of the plurality of leads; and coupling the second terminal to the battery management system.

### BRIEF DESCRIPTION OF THE DRAWINGS

A more complete understanding of embodiments described herein, and the attendant advantages and features thereof, will be more readily understood by reference to the following detailed description when considered in conjunction with the accompanying drawings wherein:

FIG. 1 shows an example battery and one or more components of the example battery according to the principles of the present disclosure;

FIG. 2 shows an example battery (e.g., exploded view) and one or more components of the example battery according to the principles of the present disclosure;

FIG. 3 shows an example case and an example post assembly of a battery according to the principles of the present disclosure;

FIG. 4 shows an example post assembly already coupled to a plurality of battery cells according to the principles of the present disclosure;

FIG. 5 shows an example battery where battery cells are being inserted in a case according to the principles of the present disclosure;

FIG. 6 shows an example battery where battery cells are inserted in a case according to the principles of the present disclosure;

FIG. 7 shows an example first cover viewed from three different angles according to the principles of the present disclosure;

FIG. 8 shows an example busbars and corresponding fasteners according to the principles of the present disclosure;

FIG. 9 shows an example bushing according to the principles of the present disclosure;

FIG. 10 shows a lateral view of the bushing and terminal shown in FIG. 9 according to the principles of the present disclosure;

FIG. 11 shows another example bushing according to the principles of the present disclosure;

FIG. 12 shows a cross-section view of the bushing shown in FIG. 11 according to the principles of the present disclosure;

FIG. 13 shows the bushing of FIGS. 11 and 12 inserted and coupled to a terminal according to the principles of the present disclosure;

FIG. 14 shows a lateral view of the bushing coupled to terminal 40 of FIG. 13 according to the principles of the present disclosure;

FIG. 15 shows an example first cover and one or more bushings according to the principles of the present disclosure;

FIG. 16 shows a cross-section view of the example first cover of FIG. 15 according to the principles of the present disclosure;

FIG. 17 shows another cross-section view of the example first cover of FIG. 15 according to the principles of the present disclosure;

FIG. 18 shows a cross-section view of the example first cover of FIG. 15 according to the principles of the present disclosure;

FIG. 19 shows an example first cover before being coupled to case according to the principles of the present disclosure;

FIG. 20 shows an example first cover coupled to case according to the principles of the present disclosure;

FIG. 21 shows an example post inserted through a respective bushing according to the principles of the present disclosure;

FIG. 22 shows another example post inserted through a respective bushing according to the principles of the present disclosure;

FIG. 23 shows an example coupling such as such as a weld according to the principles of the present disclosure;

FIG. 24 shows another example coupling such as such as a weld according to the principles of the present disclosure;

FIG. 25 shows a cross-section view of the example coupling of FIG. 23 according to the principles of the present disclosure;

FIG. 26 shows an example cross-section view of the example coupling of FIG. 24 according to the principles of the present disclosure;

FIG. 27 shows a cross section view of an example first cover according to the principles of the present disclosure;

FIG. 28 shows an example in-process cover according to the principles of the present disclosure;

FIG. 29 shows another view of the example in-process cover according to the principles of the present disclosure;

FIG. 30 shows a cross section of the example in-process cover before and after being coupled to a first cover according to the principles of the present disclosure;

FIG. 31 shows another view of the example in-process cover comprising an im-process cover seal according to the principles of the present disclosure;

FIG. 32 shows a cross-section of the example in-process cover shown in FIG. 31 according to the principles of the present disclosure;

FIG. 33 shows the example in-process cover before and after being coupled to the first cover 20 according to the principles of the present disclosure;

FIG. 34 shows a view of in-process cover according to the principles of the present disclosure;

FIG. 35 shows a cross-section of in-process cover according to the principles of the present disclosure;

FIG. 36 shows another cross-section of the in-process cover shown in FIG. 34 according to the principles of the present disclosure;

FIG. 37 shows an example of a plurality of leads according to the principles of the present disclosure;

FIG. 38 shows an example lead assembly according to the principles of the present disclosure;

FIG. 39 shows an example bushings (e.g., mini-bushing) and a lead before and after an assembly step according to the principles of the present disclosure;

FIG. 40 shows another example bushings (e.g., standard bushing) and a lead before and after an assembly step according to the principles of the present disclosure;

FIG. 41 shows an example lead assembly before and after being connected to a coupling of a corresponding post according to the principles of the present disclosure;

FIG. 42 shows an example BMS according to the principles of the present disclosure;

FIG. 43 shows an example BMS at several steps of assembly according to the principles of the present disclosure;

FIG. 44 shows an example vehicle connector according to the principles of the present disclosure;

FIG. 45 shows an example of one second cover according to the principles of the present disclosure;

FIG. 46 shows another view of the second cover of FIG. 45 according to the principles of the present disclosure;

FIG. 47 shows the cross-section view of the example second dover shown in FIG. 46 according to the principles of the present disclosure;

FIG. 48 shows another view of an example second cover according to the principles of the present disclosure;

FIG. 49 shows yet another view of an example second cover according to the principles of the present disclosure;

FIG. 50 shows an example second cover including flame arrestor plug and valve according to the principles of the present disclosure;

FIG. 51 shows an example flame arrestor plug and valve installed on the second cover according to the principles of the present disclosure;

FIG. 52 shows another view of the second cover of FIG. 51 according to the principles of the present disclosure;

FIG. 53 shows an example second cover comprising valves according to the principles of the present disclosure;

FIG. 54 shows a cross-section of an example second cover according to the principles of the present disclosure;

FIG. 55 shows another example of second cover according to the principles of the present disclosure;

FIG. 56 shows an example second cover, vehicle connector, and valve assembly according to the principles of the present disclosure;

FIG. 57 shows an in-process cover and second cover in various assembly steps according to the principles of the present disclosure;

FIG. 58 shows an example battery after the second cover is coupled to the first cover according to the principles of the present disclosure;

FIG. 59 shows an example wiring harness connected to a battery management system according to the principles of the present disclosure;

FIG. 60 shows a view of an example third cover according to the principles of the present disclosure;

FIG. 61 shows another view of the example third cover according to the principles of the present disclosure;

FIG. 62 shows an example third cover before and after being coupled to a second cover according to the principles of the present disclosure;

FIG. 63 shows an example welding interface according to the principles of the present disclosure;

FIG. 64 shows an example terminal cap before and after being coupled to a first cover and/or second cover and vehicle connector cap coupled to the second cover according to the principles of the present disclosure;

FIG. 65 shows an example process of assembly, manufacturing, and/or operating the battery according to the principles of the present disclosure;

FIG. 66 shows another example battery according to the principles of the present disclosure;

FIG. 67 shows an example first cover according to the principles of the present disclosure;

FIG. 68 shows an example second cover and an example third cover according to the principles of the present disclosure;

FIG. 69 shows the example first cover and lead assembly according to the principles of the present disclosure;

FIG. 70 shows an example first cover and lead assembly according to the principles of the present disclosure;

FIG. 71 shows an example battery management system (BMS) coupled to the lead assembly according to the principles of the present disclosure;

FIG. 72 shows another view of the example BMS coupled to the lead assembly according to the principles of the present disclosure;

FIG. 73 shows an example second cover coupled to the first cover according to the principles of the present disclosure;

FIG. 74 shows another view of the example second cover coupled to the first cover according to the principles of the present disclosure;

FIG. 75 shows an example first cover coupled to a second cover, and a third cover coupled to the second cover according to the principles of the present disclosure;

FIG. 76 shows another view of the example first cover coupled to the second cover, and the third cover coupled to the second cover according to the principles of the present disclosure;

FIG. 77 shows an example BMS according to the principles of the present disclosure;

FIG. 78 shows an example assembly method of a battery according to the principles of the present disclosure; and

FIG. 79 shows another example assembly method of a battery according to the principles of the present disclosure.

### DESCRIPTION

As battery technology evolves, there is a need to provide improved power sources, and more efficient and cost-effective methods for manufacturing such power sources as compared to conventional systems and methods.

Accordingly, embodiments described and shown herein provide a battery and method of assembly of the battery that allows smart features to be integrated within a battery that, in some embodiments, can take the same general shape and form as batteries that do not offer “smart” battery features, such as (as a non-limiting example) the ability to monitor individual cell voltages. Embodiments shown and described herein also provide a venting arrangement that is less complex than those currently used. In some embodiments, at least one lead to a corresponding battery cell may be connected to a battery management system (BMS), e.g., to determine/measure at least one parameter, such as cell voltage, cell current, cell temperature, etc. In some other embodiments, the battery includes a valve, e.g., a pressure release valve, arranged to release a pressure from the case where battery cells are housed.

In some embodiments, the term couple (or connect) may refer to physically and/or electrically coupling (e.g., connecting) one or more components. For example, coupling a first component to a second component comprises physically coupling and/or electrically coupling the first component to the second component. In some embodiments, coupling comprises casting. For example, casting a strap with a post may comprise physically and/or electrically coupling the strap to the post. In some other embodiments, coupling may further comprise coupling (e.g., physically coupling and/or electrically coupling) one or both of the first and second components to a third component.

In one or more embodiments, the term fluid may refer to a substance which may flow or conform to it container (e.g., the outline of its container). Accordingly, as used herein,, “fluid” may comprise a gas, a liquid, etc.

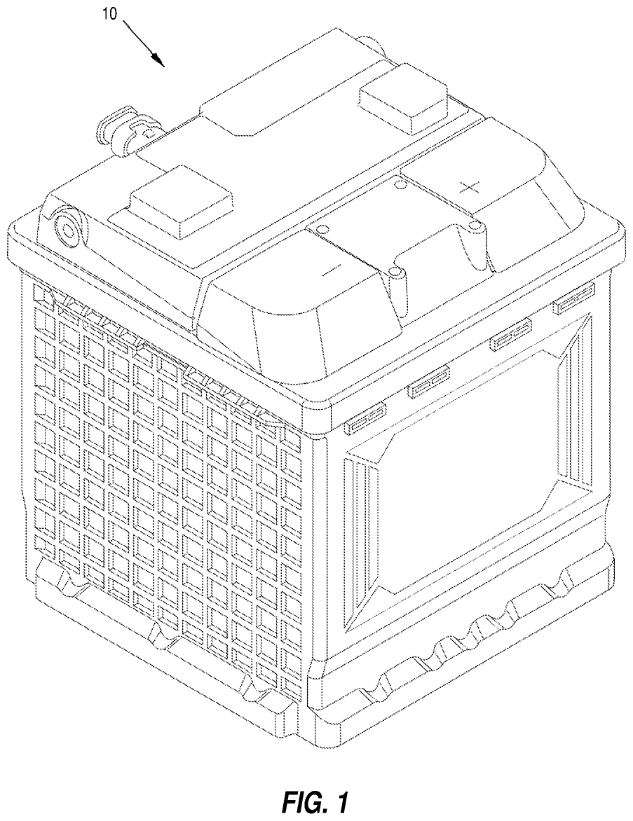

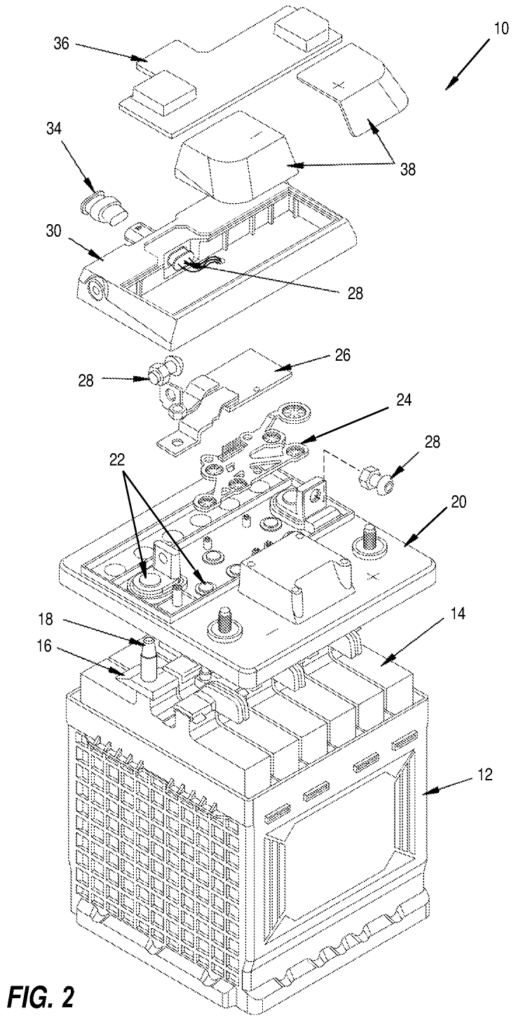

FIGS. 1 and 2 show an example battery (e.g., a lead acid battery having a smart Absorbent Glass Mat (AGM) battery assembly) and one or more components of the example battery. Battery 10 may include at least one of the following: a case 12 (which may be made of from a resin or any other suitable material), one or more battery cells 14, a post assembly 16 (e.g., Cast-On-Strap (COS) post assembly), one or more posts 18 (e.g., a terminal post, a mini-post), a first cover 20, one or more bushings 22 (e.g., a standard bushing, a mini-bushing), a lead assembly 24 (e.g., a lead frame), a battery management system 26 (e.g., including a board), one or more fasteners 28, a second cover 30, a wiring harness 32, a vehicle connector 34, a third cover 36, and one or more terminal caps 38. In one or more embodiments, the term standard may refer to or comprise U1, e.g., a standard bushing may refer to a U1 bushing, a standard post may refer to a U1 post.

In some embodiments, battery 10 may include a multi-compartment system: battery cells compartment and a BMS compartment (space comprising BMS 26). The case 12, the first, second, and third covers 20, 30, 36 (and/or any other battery components) may be made of any polymeric (e.g., polyethylene, polypropylene, a polypropylene containing material, etc.) or composite (e.g., glass-reinforced polymer) material. For example, case 12 may be made of polypropylene-containing material (e.g., pure polypropylene, co-polymers comprising polypropylene, polypropylene with additives, etc.). Such polymeric material is resistant to degradation caused by acid (e.g., sulfuric acid) provided within cells of the case. Further, and as will be discussed in more detail, a separator, which is part of the case, between the cells compartments and a space where BMS is comprised is also resistant to degradation caused by acid.

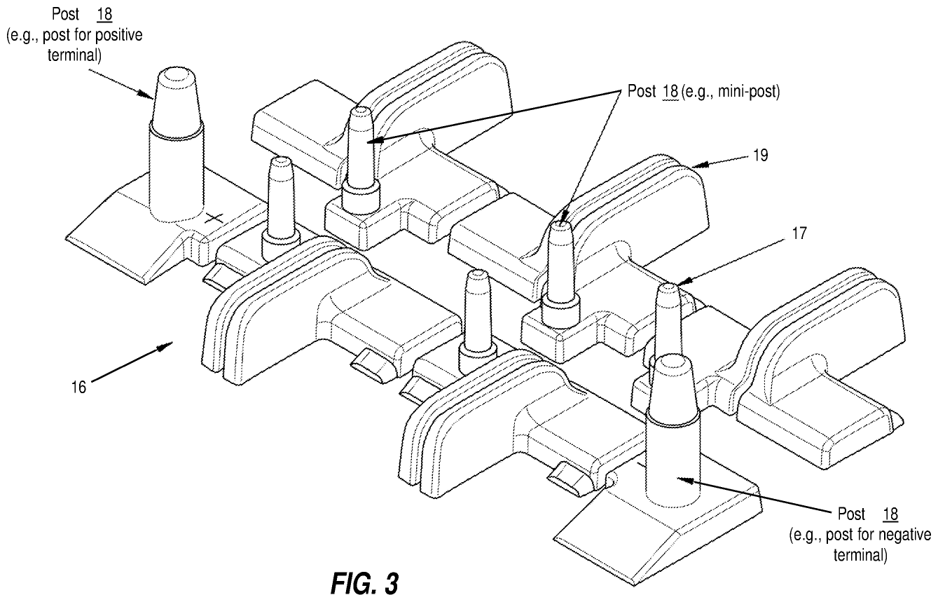

FIG. 3 shows an example post assembly 16. Post assembly 16 may include one or more straps 17, posts 18 such as a post for a positive terminal, a post for a negative terminal, and mini-posts and/or strap end 19. In some embodiments, straps 17 and/or posts 18 may be made of any material and/or coated (i.e., at least a portion) using one or more materials such as coated using an insulator material. In one nonlimiting example, straps 17 (e.g., on COS) and/or posts 18 may be made of lead and/or any other conductive material. Strap ends 19 (e.g., two strap ends) may be arranged to receive at last one cell separator 15 and/or separate one strap 17 from another strap 17 (e.g., where a cell separator 15 is in between two straps 17).

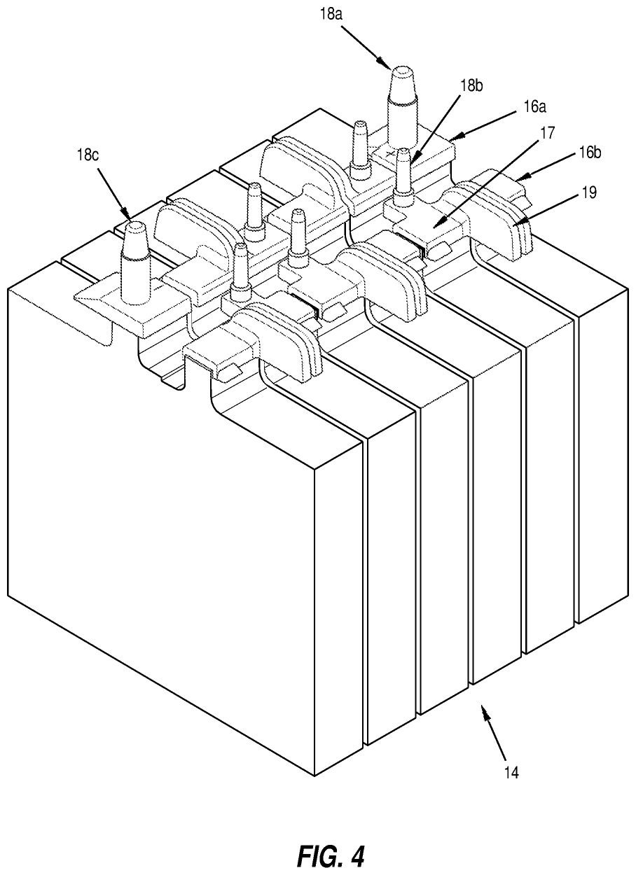

FIG. 4 shows an example post assembly 16 already coupled to the plurality of battery cells 14. Post assembly 16 may comprise post assemblies 16a, 16b. In some embodiments, post assembly 16 and/or the coupling of post assembly 16 (and/or its components) to battery cells 14 is made/performed using a COS process. In a nonlimiting example, assembly (and/or coupling) of the posts 18 (e.g., posts/COS) to the battery cells 14 may be performed by using liquid lead poured into a mold over the battery cells 14 and/or left to harden. In some embodiments, posts 18 (e.g., mini-posts 18) may be electrically coupled to single cell and allow an electrical point of contact to measure individual characteristics, e.g., voltage level, of a single cell. In some cases, battery cells 14 may be electrically connected in groups, with each post 18 being electrically connected to a group to allow measurement of the characteristics of the corresponding group of battery cells 14.

In some other embodiments, a post 18 (e.g., a first post 18a) is electrically connected to a positive electrode of one or more battery cells 14 and/or electrically connectable to a positive terminal of battery 10. In one embodiment, at least another post 18 (e.g., a second post 18b a mini post) is electrically connected to one or more battery cells 14. In some embodiments, a post 18 (e.g., a third post 18c) is electrically connected to a negative electrode of one or more battery cells 14 and/or electrically connectable to a negative terminal of battery 10. In a nonlimiting example, each one of five posts 18 (e.g., mini posts) are electrically connected to one battery cell 14 and/or one post 18 (e.g., terminal post) is electrically connected to a positive electrode and/or another post 18 (e.g., terminal post) is electrically connected to a negative electrode. In some other embodiments, each post 18 may be physically over a battery cell 14 and/or electrically coupled to the battery cell 14 and/or another battery cell 14. In a nonlimiting example, a post 18 (e.g., mini-post) located (i.e., installed) directly over a battery cell 14 may be electrically coupled to the battery cell 14. In another nonlimiting example, a post 18 (e.g., mini-post) located (i.e., installed) directly over a battery cell 14 may be electrically coupled to another battery cell 14. 15

In some embodiments, straps 17 connect a number of battery cells 14, for example, six battery cells, in series. The straps 17 may be, according to various examples of embodiments, direct path cast-on straps. The battery cells 14 may be comprised of flat-plate grids stacked together. The grids may have a lug extending out of the top of the grid. The straps 17 may be understood to connect the lugs of the grids in the battery cells 14 together.

In some embodiments, the battery straps 17 may comprise connecting straps 17 including end straps 17 corresponding to posts 18a (e.g., corresponding to the positive terminal) and 18c (e.g., corresponding to the negative terminal). Straps 17 can be arranged to couple to the lugs of a first polarity of battery plates of a battery cell 14 to the lugs of the battery plates of an opposite polarity of a second battery cell 14. In some embodiments, a terminal post 18 may be connected to an end strap 17 having a polarity (e.g., a positive terminal) which connects the lugs of plates of the same polarity (e.g., positive) of a battery cell 14. Similarly, another terminal post 18 (e.g., a negative terminal) may be connected to an end strap 17 which connects the lugs of plates (e.g., negative plates) of a battery cell 14.

In one or more embodiments, strap 17 includes post 18 that is coupled to (e.g., integrated (including cast directly on the strap), welded onto the strap, etc.) the strap 17. In some embodiments, pins may be coupled to the first cover and positioned to be in contact with the straps 17. The posts 18 may be arranged to protrude through a battery cell cover and/or penetrate the battery cell 14 and/or couple to the BMS 26. For example, each strap post may be in communication with BMS 26 to measure one or more parameters, such as voltage, of each battery cell 14 and/or a plurality of battery cells 14. The battery cell cover may be a unitary wall.

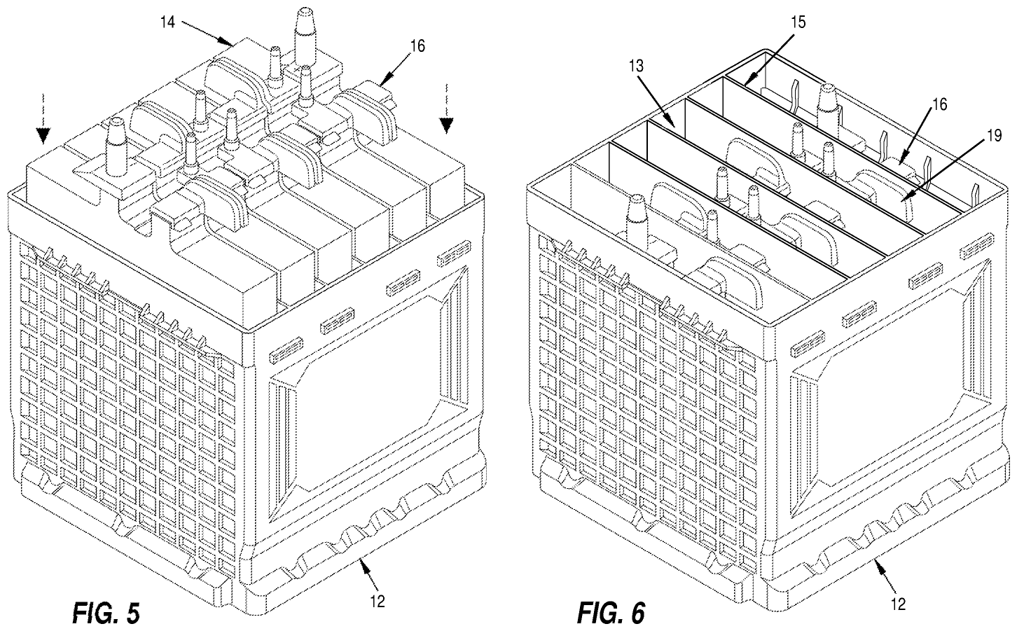

FIGS. 5 and 6 show an example battery where battery cells 14 are partially inserted (e.g., pre-stuffed) and/or fully inserted (e.g., stuffed) in the case 12. Case 12 may include one or more cell separators 15. Each battery cell 14 may be inserted in a corresponding case internal space 13 and/or be separated by one or more cell separators 15. In some embodiments, one or more battery cells 14 may be coupled, e.g., using intercell welding. In some examples, the intercell welding/coupling may comprise coupling straps/posts of one battery cell 14 to a strap/post of another battery cell 14. Further, intercell welding may include cell ribbing.

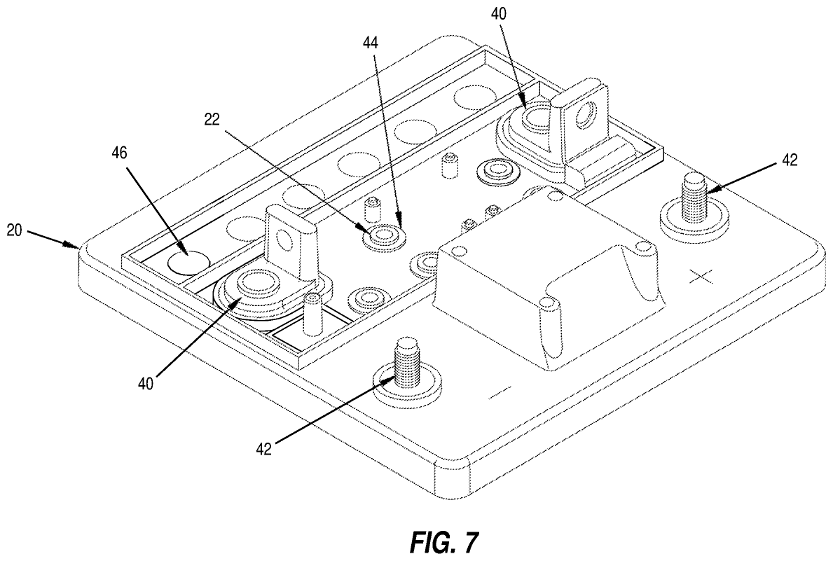

FIG. 7 shows an example first cover 20. First cover 20 may be arranged to include one or more cover openings 44. Each cover opening 44 may be arranged to receive a bushing 22 and/or a post 18. First cover 20 may also include one or more terminals 40, e.g., a positive terminal and a negative terminal each electrically connected to a corresponding terminal post 42 and/or one or more components of battery cells 14. Further, first cover 20 may comprise one or more cover openings 46 which may be arranged as vent openings, e.g., arranged to be in fluid communication with case internal space 13 (shown in FIG. 6). In addition, first cover 20 may be made of any material. For example, for lead acid batteries, first cover 20 may be made of resin, acid resistant polymers such as polypropylene (PP), etc. For non-lead acid batteries, first cover 20 may be made of any thermoplastic and/or thermoset.

In some embodiments, the inclusion of a multi-compartment system (e.g., a case internal space 13 having one or more internal spaces corresponding to each battery cell 14), the straps 17, posts 18, and sealing of battery cells (and/or first cover 20 to case 12) prevent any acid from escaping the case internal space 13 and exposing electronics or electrical components to the acid/electrolyte. In some other embodiments, the intelligence of the smart lead-acid battery (e.g., lead assembly 24, BMS 26) does not need to be potted for long-term acid exposure such as in conventional lead-acid batteries. The posts (e.g., mini-posts) may be each in communication with the BMS 26 (or a board 67 of the BMS 26) using flexible connectors of a spider-leg connector. Additionally, the BMS 26 may include additional connectors such as couplers 48 or bus bars for current and voltage measurements.

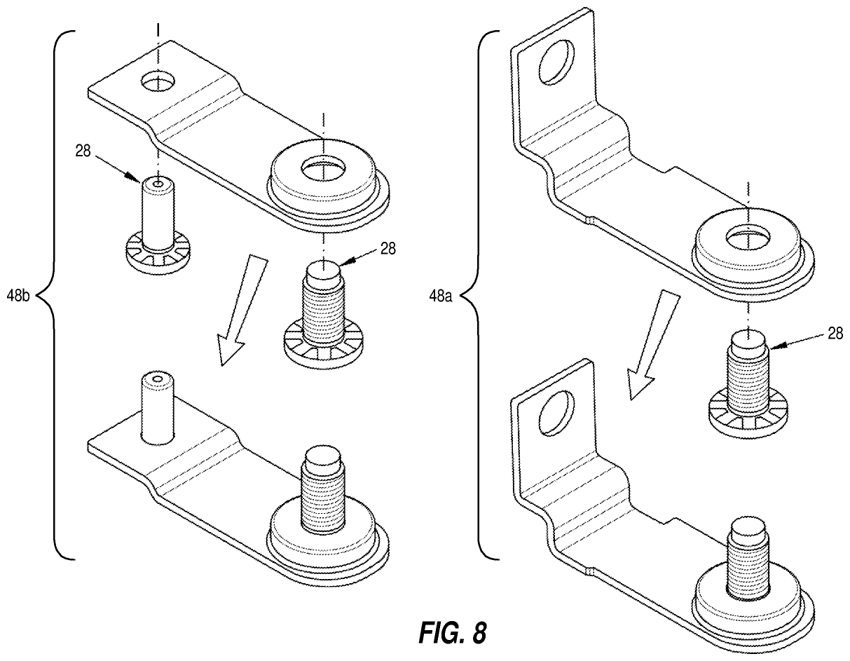

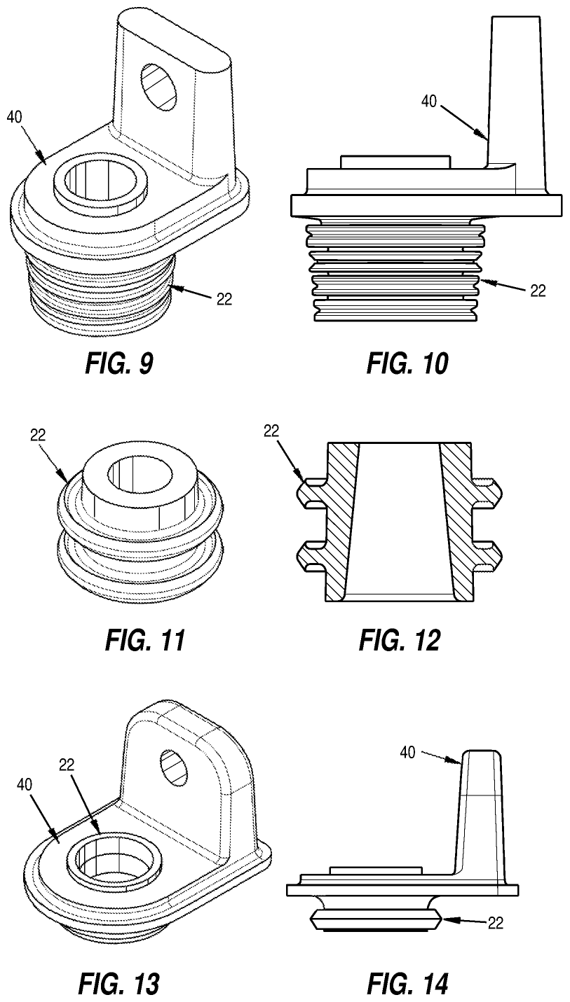

In addition, first cover 20 may include one or more components such as couplers 48 and/or bushings 22 as shown in FIGS. 8-13, respectively. Each coupler 48 may include one or more coupler parts and be arranged to couple to one or more battery components, e.g., of the first cover. More specifically, FIG. 8 shows an example coupler 48a (e.g., couplable to a positive terminal) and another example coupler 48b (e.g., couplable to a negative terminal) and corresponding fasteners 28. FIG. 9 shows an example bushing 22 such as bushing 22a (e.g., a standard bushing) which may correspond and/or be coupled to (e.g., inserted in) terminal 40 (and/or a post for a terminal 40). FIG. 10 shows a lateral view of the bushing 22 and terminal 40 shown in FIG. 9. FIG. 11 shows another example bushing 22 such as 22b which may correspond and/or be coupled to (e.g., inserted in) another terminal 40 (and/or a post for terminal 40). In some embodiments, example bushing 22 such as 22b is a mini-bushing which may correspond and/or be coupled to a post 18 such as a mini-post. FIG. 12 shows a cross-section view of the bushing 22 shown in FIG. 11. FIG. 13 shows the bushing of FIGS. 11 and 12 inserted and coupled to a terminal 40. FIG. 14 shows a lateral view of the bushing 22 coupled to terminal 40 of FIG. 13. Further, bushings 22 may be arranged to be inserted in any opening such as cover opening 44 and/or receive a post 18 (such as a mini-post and/or a standard post). Bushings 22 may be arranged to electrically couple to one or more battery components such as posts 18. For example, bushings 22 can be made of one or more materials (e.g., lead, bronze, gold, etc.). However, bushings 22 are not limited as such and bushings 22 may be arranged to provide friction reduction between parts (e.g., post 18 and/or cover opening 46) and/or electrical insulation between parts (e.g., post 18 and/or cover opening 46).

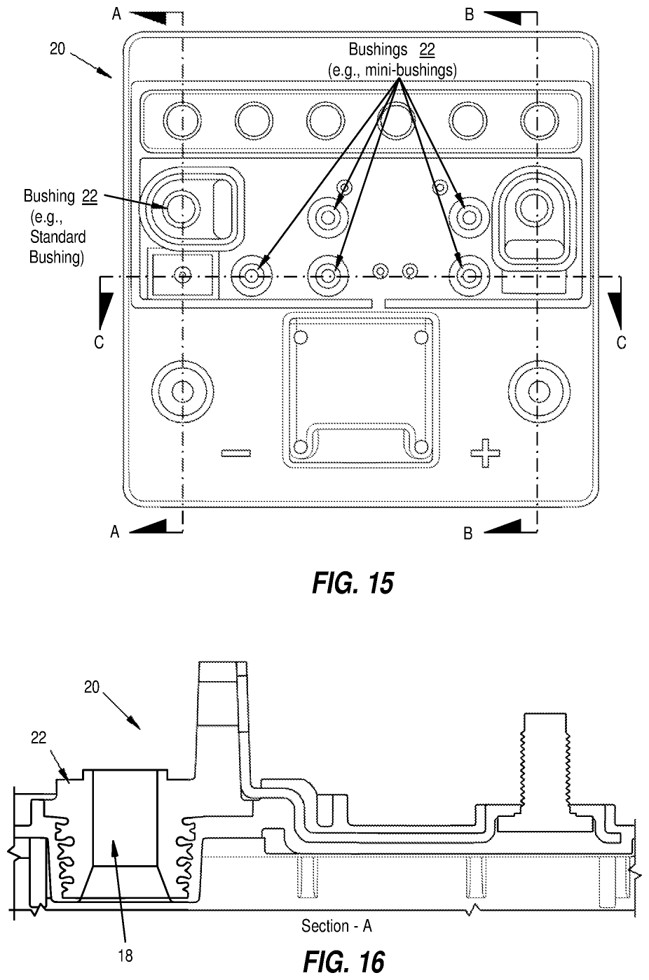

FIG. 15 shows an example first cover 20 and one or more bushings 22. In this nonlimiting example, first cover 20 may include one or more bushings 22 such as mini-bushings and one or more bushings 22 such as standard bushings. In some embodiments, a standard bushing may refer to a bushing arranged to conform to the specifications of one or more parts of a standard type of battery. For example, a standard bushing may be arranged to conform to the shape/size of a standard post (i.e., a post meeting the specifications of a standard battery such as a terminal post). In some other embodiments, a mini-bushing may refer to a bushing arranged to conform to the specifications of one or more mini-posts. Although standard bushings have been described in the example above, bushing 22 may be any kind of bushing.

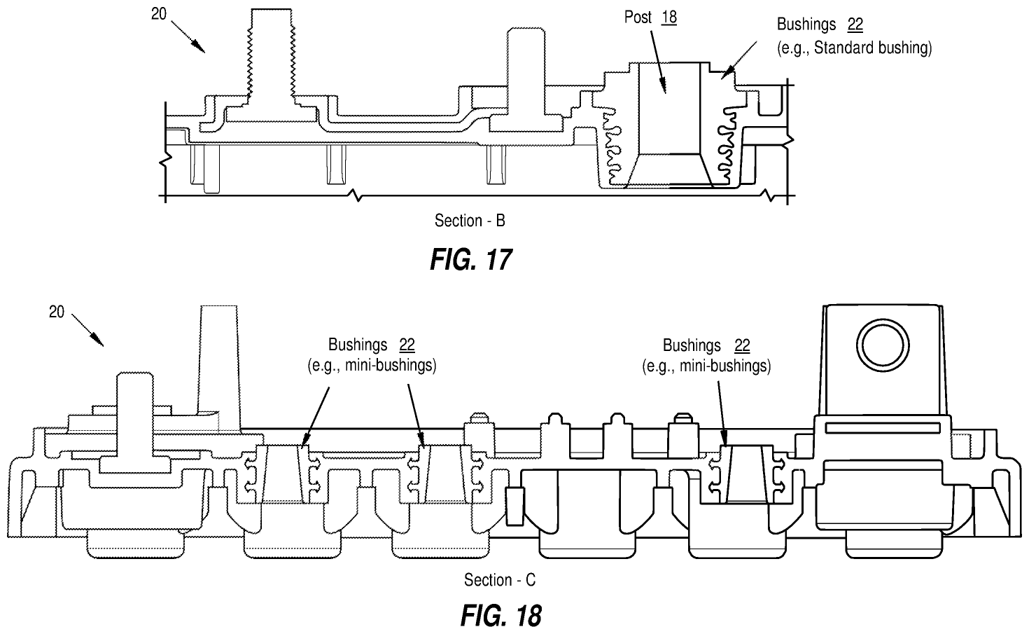

FIG. 16 shows a cross-section view of the example first cover 20 of FIG. 15. In a nonlimiting example, first cover 20 is coupled to the case 12 using a heat seal. Posts 18 (e.g., terminal post corresponding to a negative terminal) are inserted through a corresponding a bushing 22. FIG. 17 shows another cross-section view of the example first cover 20 of FIG. 15. Posts 18 (e.g., terminal post corresponding to a positive terminal) are inserted through a corresponding a bushing 22. FIG. 18 shows a cross-section view of the example first cover 20 of FIG. 15, which comprises bushings 22 (e.g., mini-bushings arranged to receive and couple to a post 18 such as a mini-post that is connected to a battery cell). A bushing 22 may be used as to provide sealing features, where coupling a bushing 22 to first cover 20 seals the bushing 22 to the first cover 20.

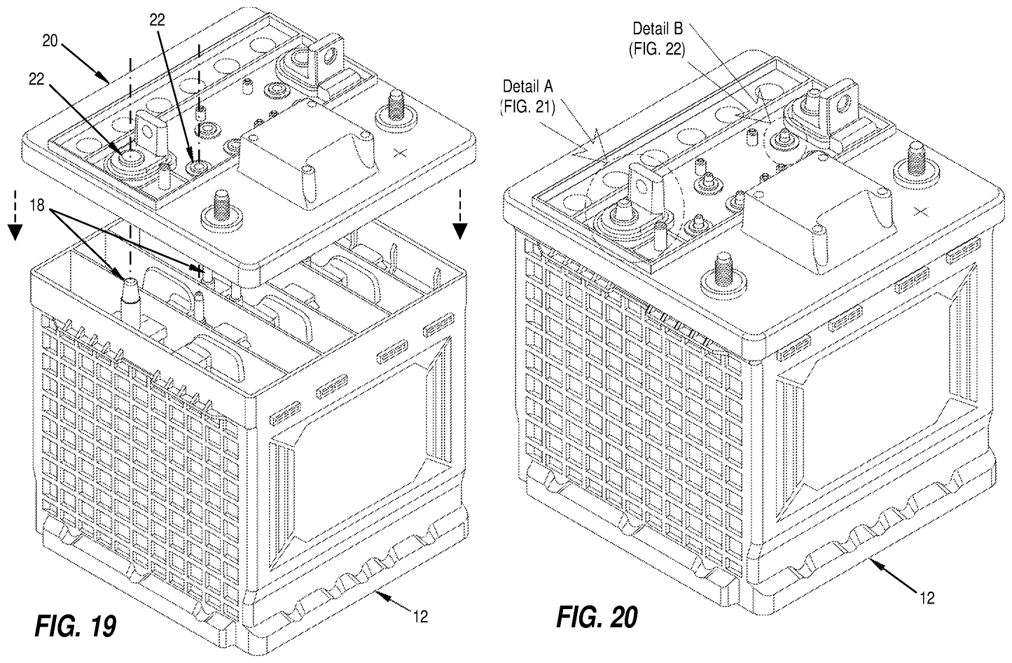

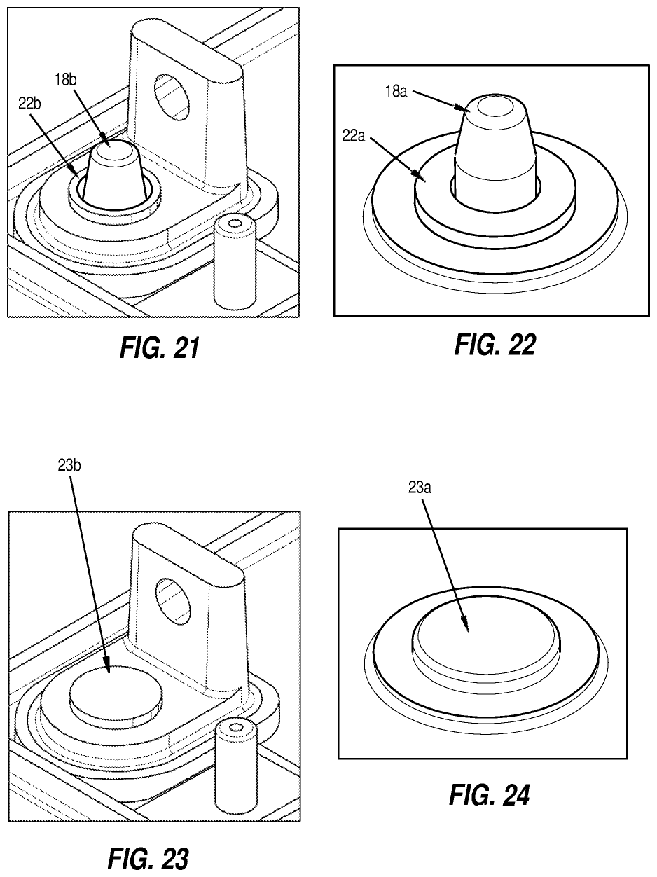

FIG. 19 shows an example first cover 20 before being coupled to case 12. First cover 20 may be aligned with case 12. Further, bushings 22 may be aligned with corresponding posts 18 before the first cover 20 is coupled to the case 12. FIG. 20 shows first cover 20 coupled to case 12. FIGS. 21 and 22 show posts 18 inserted through a respective bushing 22, e.g., post 18a such as a mini-post is inserted (and/or coupled to) bushing 22a such as a mini-bushing, and post 18b such as a standard post is inserted (and/or coupled to) bushing 22b such as a standard bushing. At least a portion of the post 18 protrudes out of first cover 20 (e.g., out of the cover opening 46). In a nonlimiting example, a portion of a post 18a (e.g., a mini-post) protrudes out of bushing 22a of the first cover 20 and/or a portion of another post 18b (e.g., a post for a negative terminal) protrudes out of bushing 22 of the first cover 20.

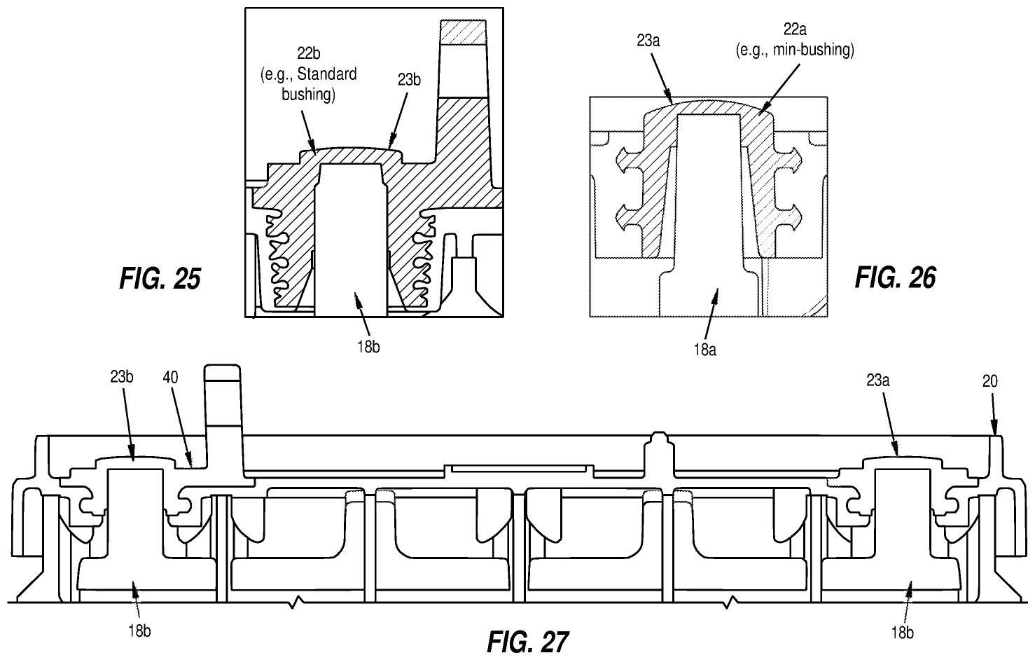

FIGS. 23 and 24 show coupling 23 (i.e., 23a, 23b) such as such as a weld. In some embodiments, coupling 23 comprises bushings 22 and post 18 coupled to bushing 22, e.g., after a post burn process or weld process. In some embodiments, the coupling of posts 18 and bushings 22 causes posts 18 and bushings 22 to be sealed to first cover 20. FIGS. 25 and 26 show cross-section views of couplings 23 of FIGS. 23 and 24, respectively. Similarly, FIG. 27 shows a cross section view of first cover 20 comprising couplings 23 of FIGS. 23 and 24 and posts 18.

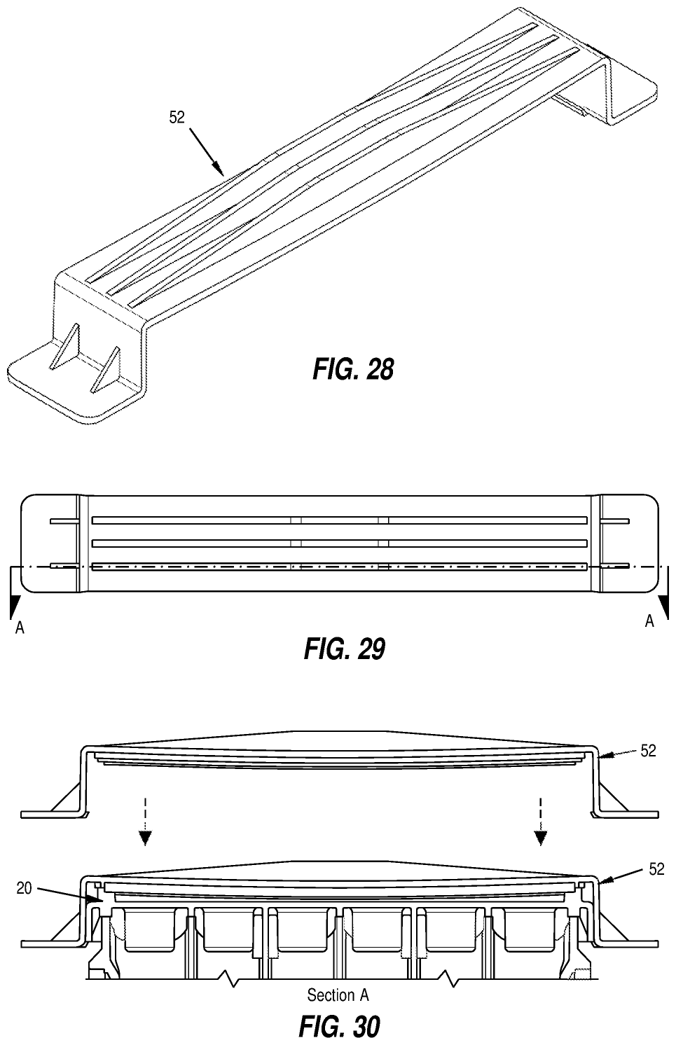

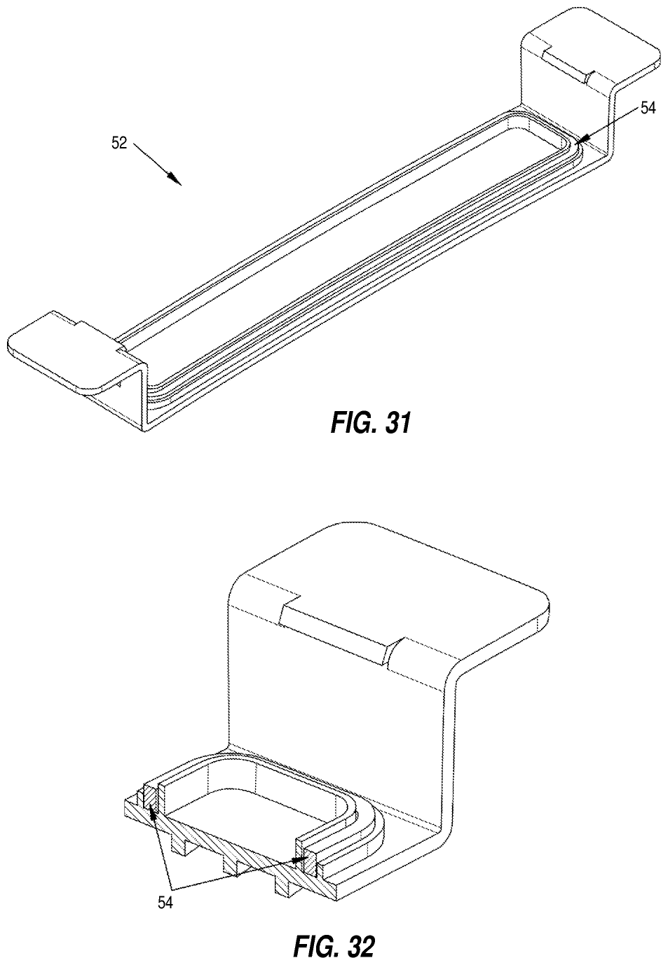

FIG. 28 shows an example in-process cover 52 according to some embodiments. In-process cover 52 may be configured to cover one or more openings of the first cover 20 during manufacturing or assembly of battery 10. FIG. 29 shows another view of in-process cover 52. FIG. 30 shows a cross section of in-process cover 52 before and after being coupled to first cover 20. FIG. 31 shows another view of in-process cover 52 comprising an im-process cover seal 54 arranged to seal in-process cover 52 to first cover 20. FIG. 32 shows a cross-section of the in-process cover 52 shown in FIG. 31. In-process cover 52 may be a snap-on cover and/or may include an in-process cover seal 54 such as an over molded rubber seal.

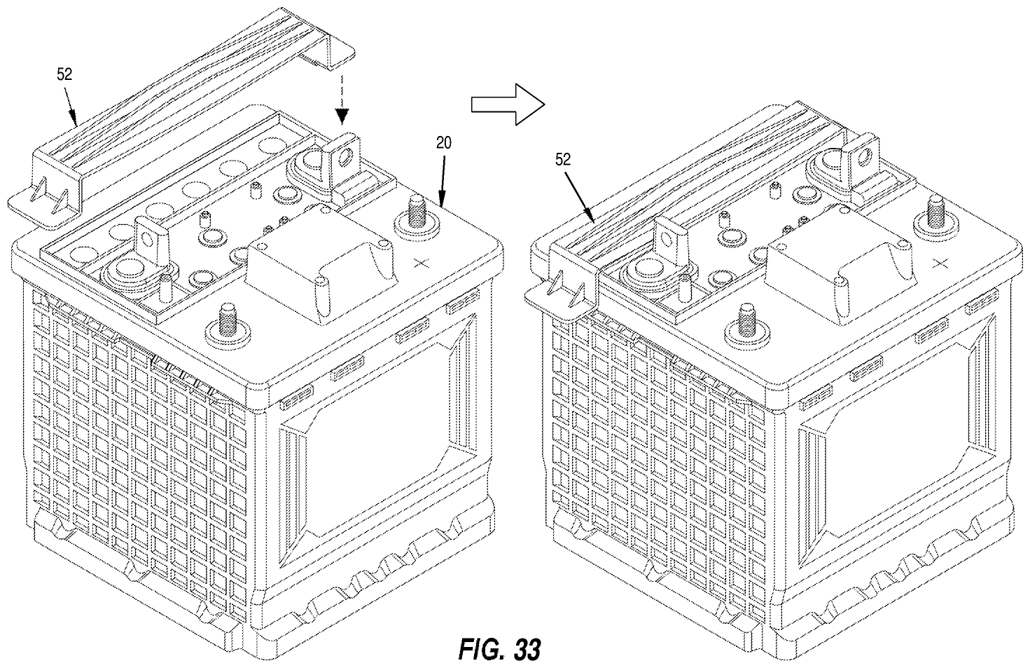

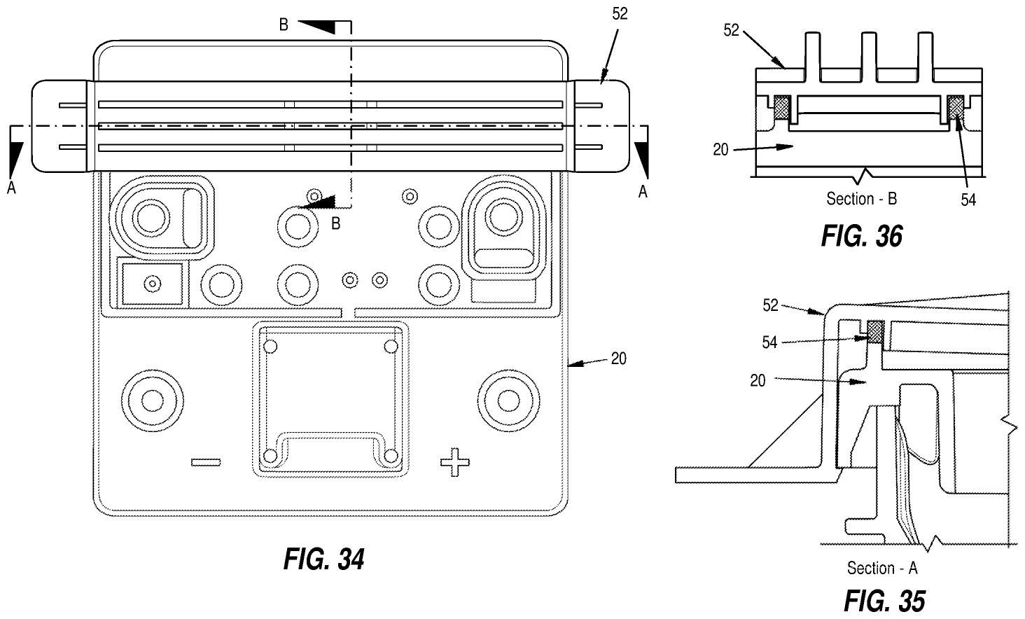

FIG. 33 shows the example in-process cover 52 before and after being coupled to first cover 20, i.e., steps of a process (e.g., assembly process) for coupling the in-process cover. In-process cover 52 may be arranged to cover any openings of first cover 20, e.g., to avoid any material entering case 12 and/or case internal space 13. FIG. 34 shows a view of in-process cover 52 (coupled to first cover 20 using in-process cover seal 54) and indications of cross sections A, B. FIG. 35 shows a cross-section (e.g., A) of in-process cover 52 shown in FIG. 34. FIG. 36 shows another cross-section (e.g., B) of in-process cover 52 shown in FIG. 34.

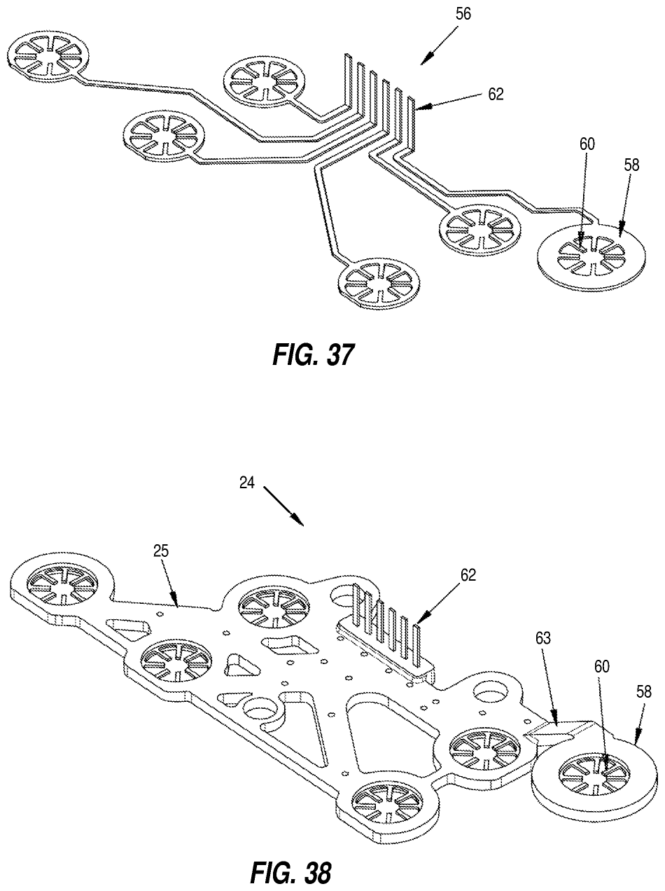

FIG. 37 shows an example of a plurality of leads 56 (e.g., six leads) and a lead assembly (e.g., including the plurality of leads 56). Each lead 56 may include one or more of each of the following: a lead ring 58, a post connector 60 (e.g., a spoke) comprised in one end each lead 56, and a lead BMS connector 62 (e.g., pin, space, etc.) comprised in another end of each lead 56. Ring 58 and/or post connector 60 may be arranged to physically and/or electrically connect lead 56 to a post 18 (e.g., by being coupled (e.g., by welding it) to coupling 23). BMS connector 62 may be arranged to extend from the ring and/or bend to a predetermined angle and/or physically and/or electrically connect to BMS 26 (and/or any of its components). Lead 56 may be made of any material including conductive materials, e.g., to conduct electricity and/or propagate signals. In a nonlimiting example, lead 56 may refer to a stamped frame and/or be made of at least one of copper, brass, steel, aluminum, titanium, platinum, etc. Further, lead 56 may include a coating and/or a finish such as a finish using copper, nickel, tin, palladium, silver, gold, zinc, etc. Lead 56 may be used by BMS 26 to measure/determine one or more parameters associated with a post 18 and/or corresponding battery cell 14. Parameters may include, without limitation, voltage, current, temperature, pressure, etc., and may be associated with any component of battery 10, e.g., post 18, battery cell 14, etc. Lead(s) 56 (e.g., stamped leads) may be comprised in a lead assembly 24, e.g., an over molded assembly) as shown in FIG. 38. The lead assembly 24 may comprise lead frame 25. In some embodiments, lead frame 25 is the coating and/or finish described in FIG. 37. Further, lead assembly 24 may comprise one or more openings arranged for coupling lead assembly 24 to first cover 20.

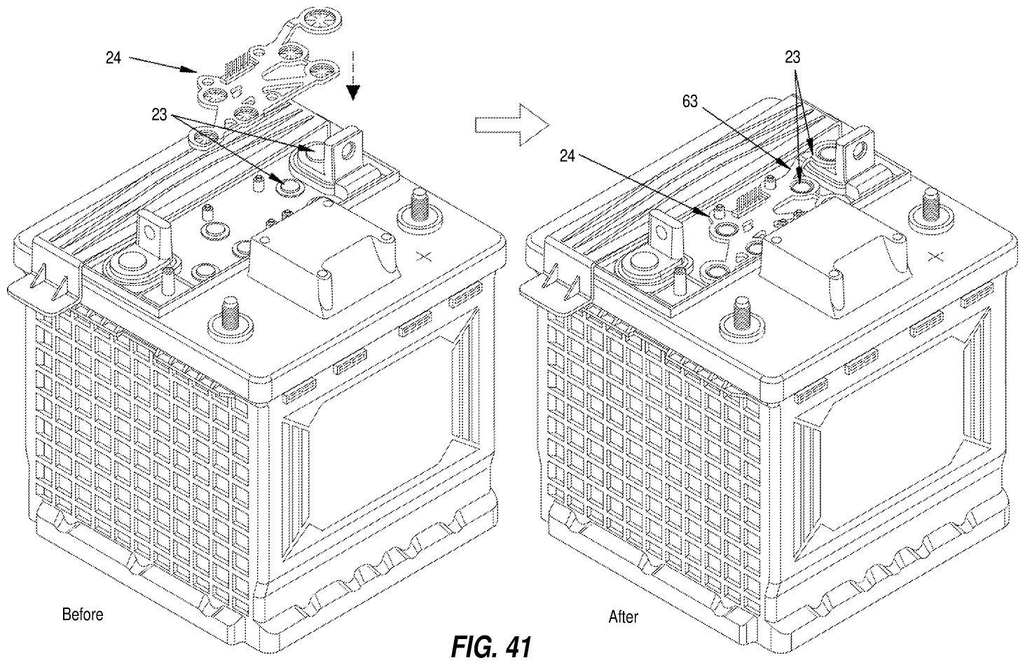

Any portion of each lead 56 may be hinged and/or adapted to be flexible and/or adjustable, e.g., to connect lead 56 to a post 18 that may be in a different plane than a plane corresponding to another portion of lead assembly 24. A terminal 40 (e.g., positive terminal 40 shown in FIG. 41) and/or corresponding post 18 may be located on a different plane than a plane where other posts 18 (e.g., mini-posts) are located. In other words, it is contemplated that terminals 40 and posts 18 need not be co-planar with respect to the top surface of the battery case 12. In a nonlimiting example, lead assembly 24 includes arm 63 which may be arranged to adjust the location of a portion of lead assembly 24, e.g., corresponding to a predetermined post 18 such as a portion that includes a ring 58 and/or post connector 60 for a positive terminal post that is not coplanar with others of the rings 58 in the lead assembly 24. In some embodiments, arm 63 can be pivotable to allow for adjustment. By having arm 63 adjustable, lead assembly 24 may be arranged to fit one or more posts/terminals having different locations. Further, ring 58 and post connector 60 may be sized based on a post type and/or any other parameter. In a nonlimiting example, ring 58 and/or post connector 60 may be made thicker and/or have a greater diameter than other rings 58 and/or post connectors 60 of lead assembly 24, e.g., to fit a size and type of a post of a positive terminal having a greater size and current rating. In a nonlimiting example, ring 58 and/or post connector 60 may be made thinner and/or have a smaller diameter than other rings 58 and/or post connectors 60 of lead assembly 24, e.g., to fit a size and type of a mini-post used to receive/transmit/measure a battery parameter. Lead assembly 24 can be made by overmolding a polymer (e.g., to make lead frame 25) over the leads 56 to thereby provide structure for the leads 56. Lead assembly 24 can be rigid or flexible or a combination thereof depending on the intended design.

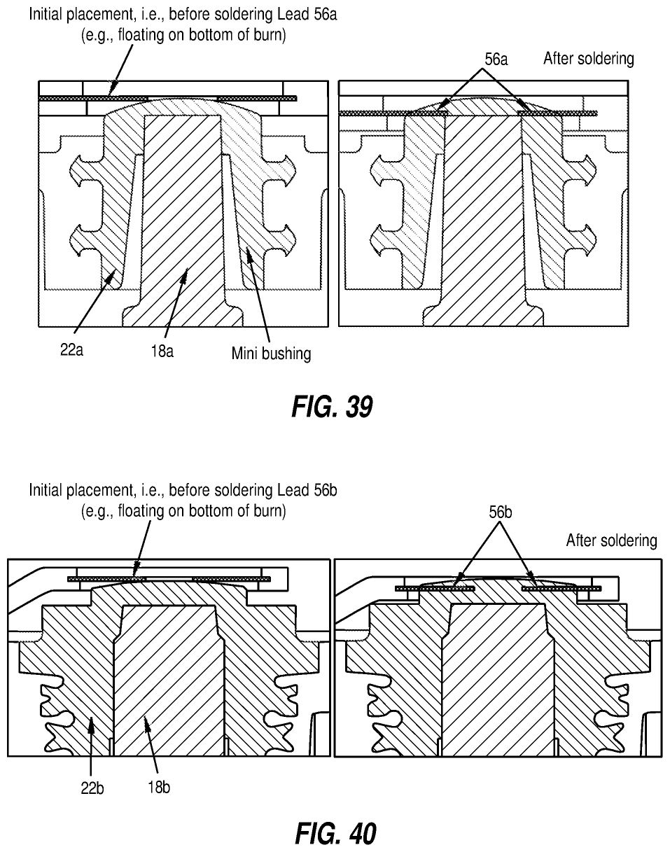

FIG. 39 shows an example bushings 22 (e.g., mini-bushing) and lead 56 before and after an assembly step. Lead 56a may be placed floating, e.g., placed on top of bushing 22a (e.g., a mini-bushing). After a heating step (e.g., soldering) is completed, lead 56a makes contact (e.g., physical, electrical) with a portion of post 18a. FIG. 40 shows another example bushings 22 (e.g., standard bushing) and lead 56 before and after an assembly step. Lead 56b may be placed floating, e.g., placed on top of bushing 22b (e.g., a standard bushing). After a heating step (e.g., soldering) is completed, lead 56b makes contact (e.g., physical, electrical) with a portion of post 18b. FIG. 41 shows an example lead assembly 24 before and after being connected to a coupling 23 of a corresponding post 18, i.e., an assembly step. Lead assembly 24 may also be placed on first cover 20 and/or coupled to first cover 20, e.g., using one or more fasteners 28.

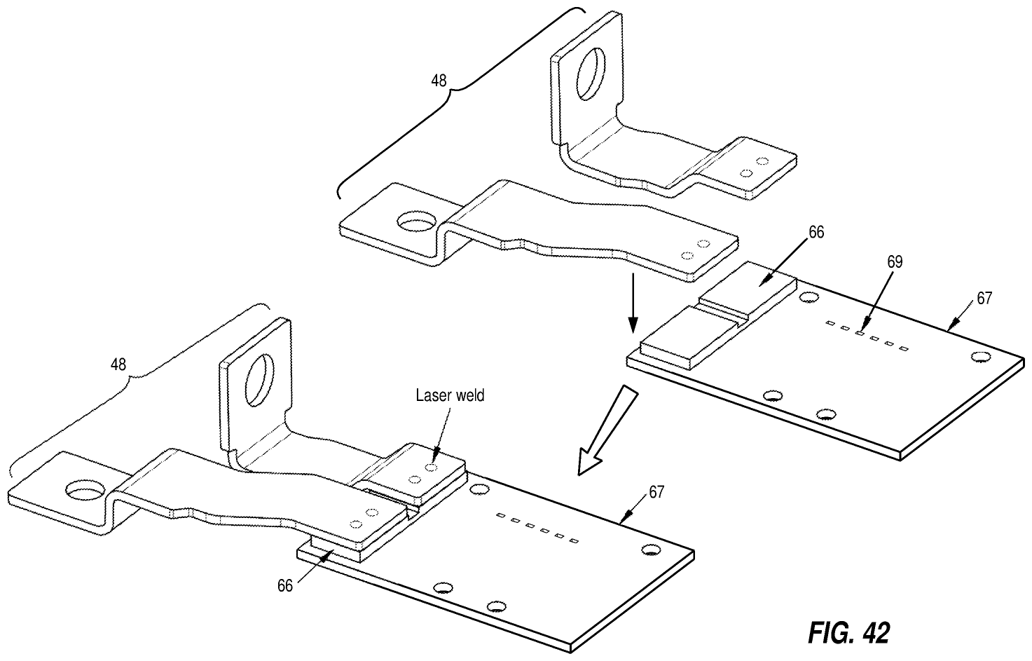

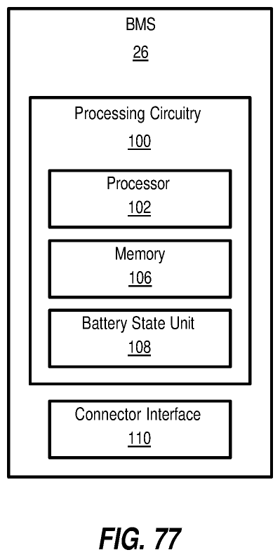

FIG. 42 shows an example BMS 26, including board 67 and board openings 69, before and after being coupled to one or more couplers 48, i.e., a coupling step of an assembly process. Board 67 may comprise components as shown in FIG. 77. Board openings may be arranged to receive and/or couple to BMS connectors 62. In this nonlimiting example, board 67 may be coupled to couplers 48a, 48b directly or indirectly (e.g., via coupler receiver 66). Coupling may include laser welding. Couplers 48a, 48b may be arranged to couple to one or more posts such as terminal posts 18, e.g., for a ground connection.

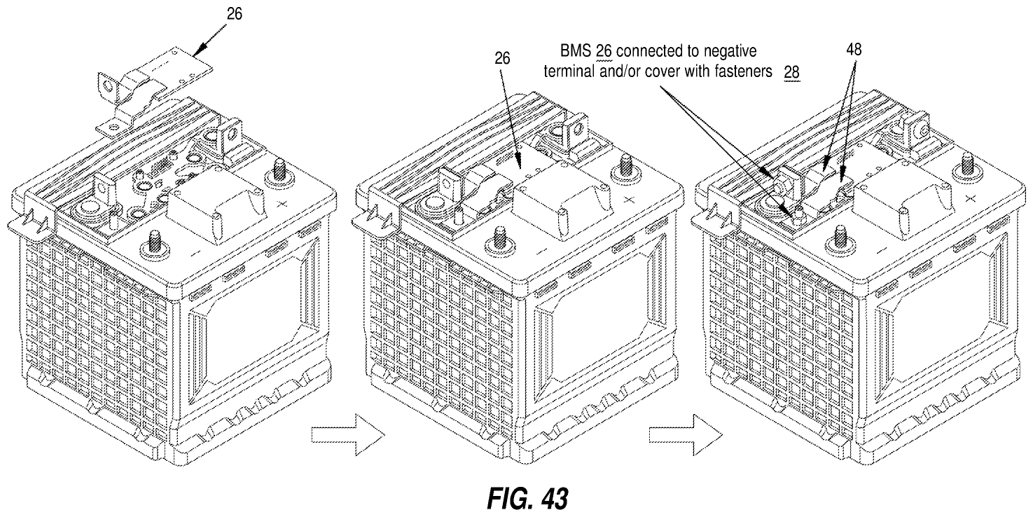

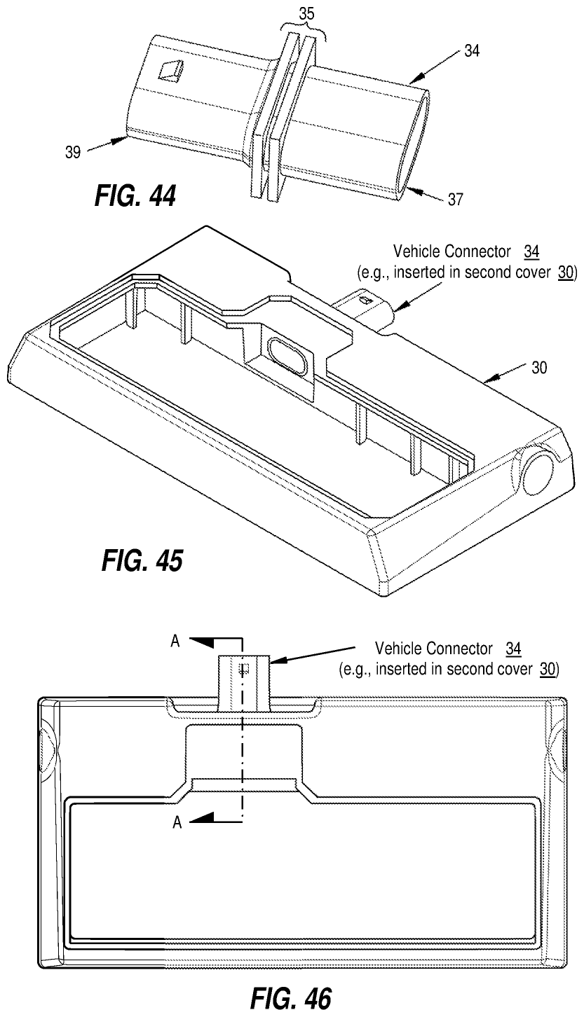

Further, FIG. 43 shows an example BMS 26 before being placed on first cover 20, after being placed on first cover 20, and after being connected to a negative terminal of battery 10 using fasteners 28. In this nonlimiting example, BMS 26 is electrically connected (e.g., using one fastener 28 and a coupler 48) to a negative terminal of the battery 10 and mechanically coupled to first cover 20 (using another coupler 48 and another fastener 28 already coupled to first cover 20).

FIG. 44 shows an example vehicle connector 34 arranged to couple to second cover 30 and/or provide a conduit for one or more conductors electrically connectable to BMS 26 and/or a vehicle. Vehicle connector 34 comprises a cover end 37 and a vehicle end 39. Cover end 37 may be arranged to couple to second cover 30, and vehicle end 39 may be arranged as an interface to one or more vehicle systems. Further, vehicle connector 34 may comprise one or more walls 35 which may be arranged as a coupling device and/or to provide a biasing force to prevent vehicle connector from being decoupled from second cover 30.

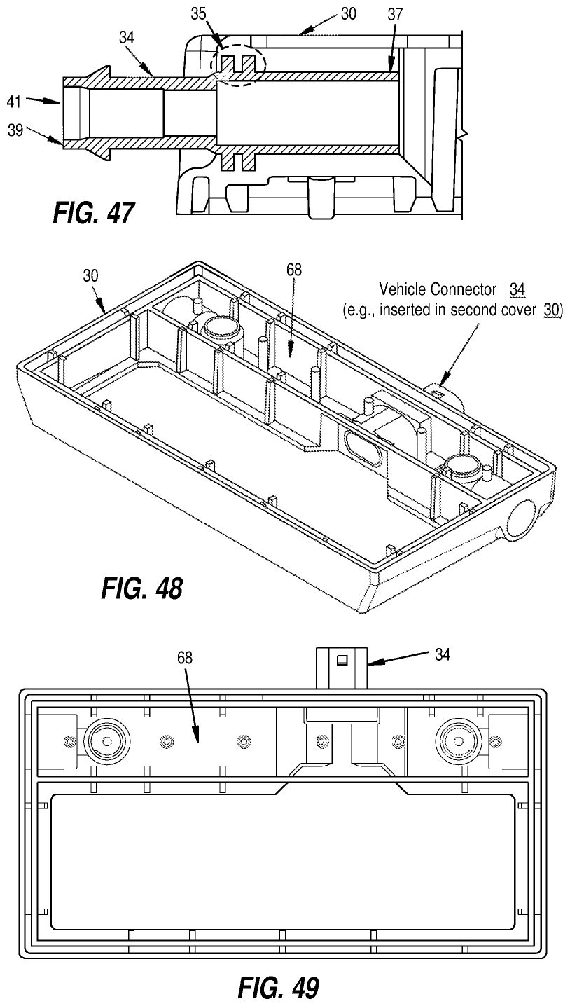

FIG. 45 shows an example of one second cover 30 and one vehicle connector 34 coupled to second cover 30. FIG. 46 shows another view of the second cover of FIG. 45 and an indication A of a cross-section view. FIG. 47 shows the cross-section view A indicated in FIG. 46. The cross section of the vehicle connector 34 shows a connector barrel 41 which may be arranged as the conduit described with respect to FIG. 44. More specifically, vehicle connector 34 may be arranged to receive at least one wire, of a wire harness, e.g., so that a connection from BMS 26 to a component of a vehicle via the wire harness can be made. FIGS. 48 and 49 show other views of second cover 30 and vehicle connector 34. Second cover 30 may comprise or define a cover space 68. Second cover 30 can be made of the same material(s) as first cover 20 or any other material. For example, for lead acid batteries, second cover 30 may be made of resin, acid resistant polymers such as polypropylene (PP), etc. For non-lead acid batteries, second cover 30 may be made of any thermoplastic and/or thermoset.

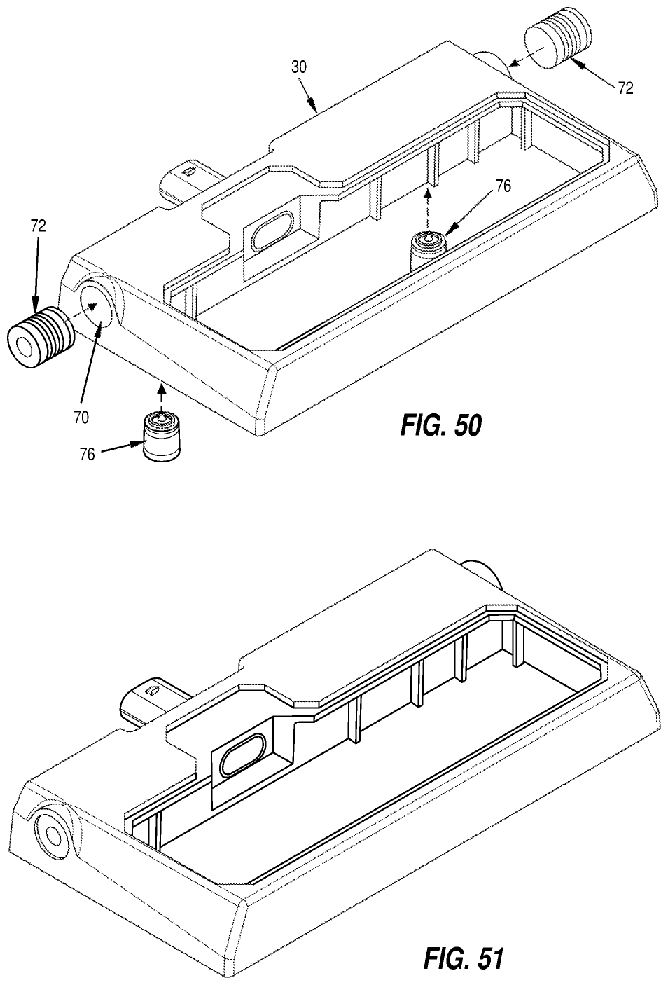

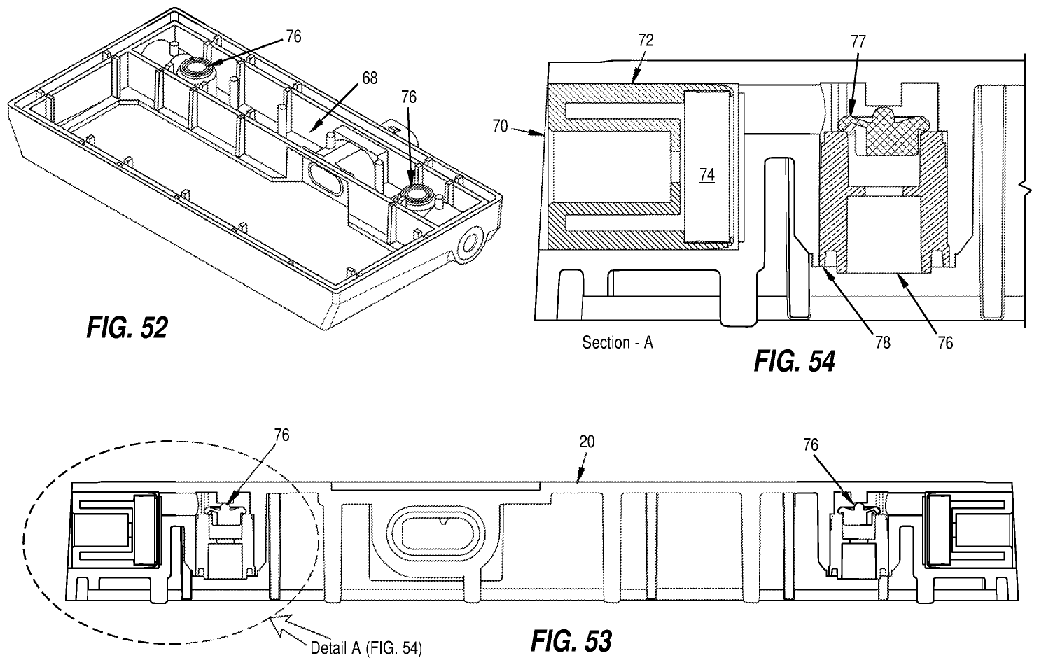

FIG. 50 shows an example second cover 30 including flame arrestor plug 72 and valve 76 being installed on second cover 30. FIG. 51 shows flame arrestor plug 72 and valve 76 installed on second cover 30. FIG. 52 shows another view of the second cover of FIG. 51 showing valves 76 coupled to (i.e., installed on) second cover 30. FIG. 53 shows second cover 30 comprising valves 76 and an indication A of a cross-section. FIG. 54 shows a cross-section A of the second cover 30 and its components. More specifically, second cover 30 may have one or more vent ports 70, which may be arranged to receive a flame arrestor plug 72 (i.e., any member arranged to seal/plug an opening such as vent port 70). Further, second cover 30 may be arranged to receive one or more valves 76 within cover space 68. Steps of assembly of second cover 30 may then include coupling at least one flame arrestor plug 72 to a corresponding vent port 70 and/or one or more valves 76 to second cover 30. That is, once valve 76 is installed and/or received by second cover 30, valve 76 (i.e., an internal portion of the valve) is in fluid communication with cover space 68 (which may be in fluid communication with case 12 and/or case internal space 13). Valve 76 (i.e., an external portion of the valve) may also be in fluid communication with the flame arrestor plug and/or the environment exterior to second cover 30 and/or battery 10. Valve 76 may include valve head 77, where a portion of valve head 77 is arranged to release fluid when the fluid reaches a predetermined pressure threshold. A portion of valve head 77 may be in contact with a portion of the second cover 30 such that the portion is secured (e.g., is kept within a predetermined space) when subjected to a predetermined pressure, while another portion of valve head 77 opens to release fluid when subjected to the predetermined pressure.

Further, valve 76 may be arranged to have one or more valve states, e.g., closed, open, throttling (e.g., to maintain a parameter), partially open, partially closed, etc. In a nonlimiting example, valve 76 may be closed. When valve 76 is closed, a pressure (e.g., of a fluid) throughout several portions of battery 10 may be kept (e.g., by valve 76 and/or heat seal 78) the same and/or within a predetermined pressure difference. For example, the pressure around battery cells 14 and/or cover space 68 and/or case 12 and/or case internal space 13 may be kept within the predetermined pressure difference. In another nonlimiting example, valve 76 may be arranged to open (e.g., via valve head 77) when a pressure (e.g., a pressure of a fluid) within the cover space 68 (and/or case 12 and/or case internal space 13) exceeds a predetermined threshold. Opening valve 76 may allow a fluid (and/or any other matter) within the cover space 68 (and/or case 12 and/or case internal space 13) to exit the battery 10 through the valve 76 and flame arrestor plug 72 (e.g., including flame arrestor 74). In other words, the arrangement of case 12 and/or first cover 20 and/or second cover 30 and/or valve 76 and/or any other component of battery 10 allows battery 10 to keep a uniform pressure around components of battery 10 and/or release pressure based on a predetermined threshold. In some embodiments, flame arrestor 74 can be a separate structure (e.g., not comprised in flame arrestor plug 72) that is coupled to the second cover 30.

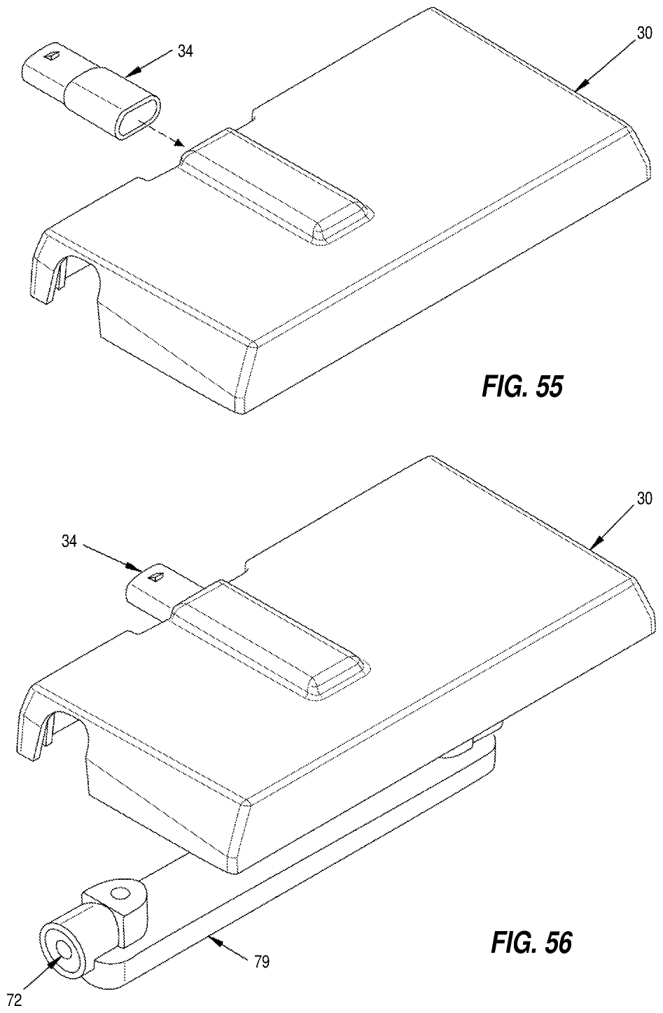

FIG. 55 shows another example of second cover 30 and vehicle connector 34. FIG. 56 shows the second cover 30 and vehicle connector 34 in addition to a valve assembly 79. Valve assembly 79 is couplable to second cover 30 and may be arranged to receive valves 76 and/or accumulate fluid from the battery internal space. For example, when valves 76 are coupled to valve assembly 79, the assembly may be arranged to release fluid via plugs 72. Valve assembly 79 may be releasably coupled to second cover 30.

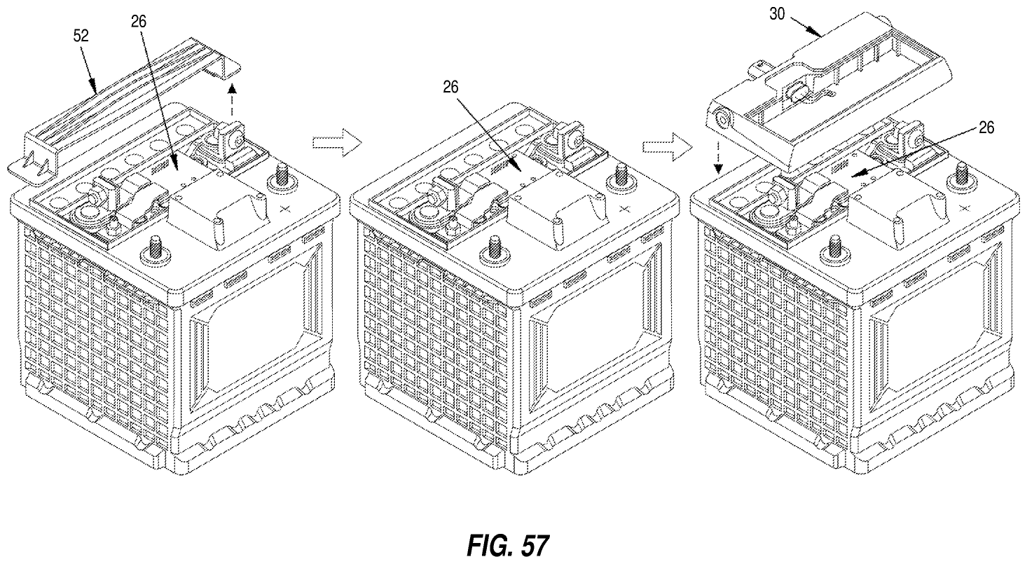

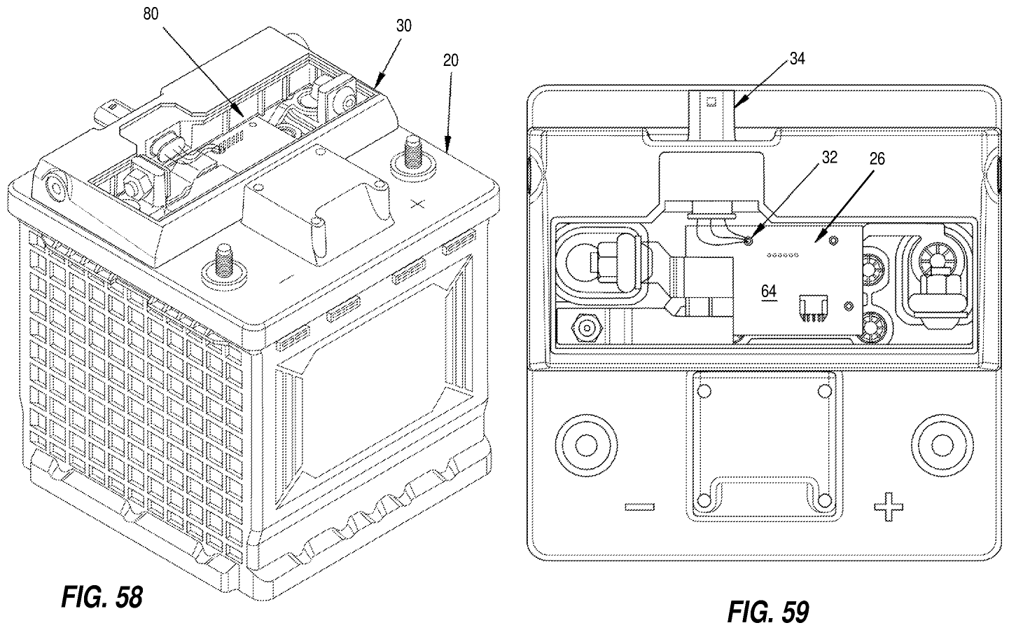

FIG. 57 shows an example battery 10 when in-process cover 52 is being removed, after in-process cover 52 is removed, and second cover 30 is being coupled to first cover 20 of battery 10. Second cover 30, after being coupled, may provide access to BMS 26. FIG. 58 shows an example battery 10 after second cover 30 is coupled to first cover 20, which may be performed using a heating process such as infrared welding, heat sealing, etc. Second cover 30 may include access opening 80, e.g., defining a space for other components such as BMS 26 to be accessed/installed/maintained after second cover 30 has been coupled to first cover 20. FIG. 59 shows wiring harness 32 connected to BMS 26 (and/or board 64), e.g., using a pig-tail of the wiring harness 32 and/or vehicle connector 34.

In some embodiments, the space defined by access opening 80 (e.g., a BMS compartment) includes the BMS 26 which may comprise a connector interface configured to receive and/or transmit signals from external devices, such as a vehicle via the vehicle connector 34. For example, the connector interface may be connected to the BMS 26 using a flexible harness or a plurality of flexible wires. Further, BMS 26 may include parameter sensors. Parameter sensors may include voltage sensors for measuring cell voltages and/or a module voltage, a current sensor for measuring a module current, one or more temperature sensors for measuring various temperatures such as module temperature, compartment temperature.

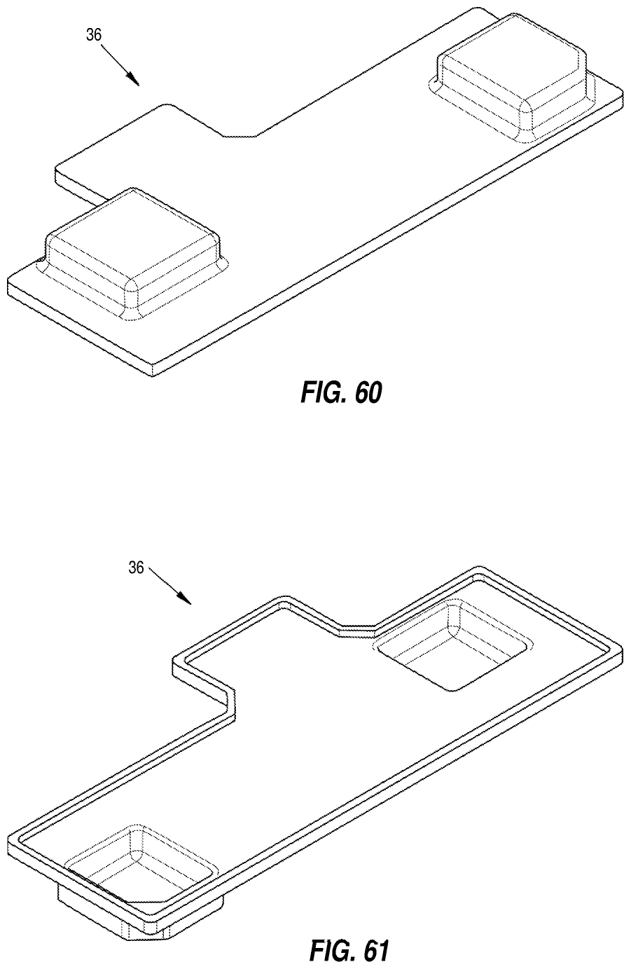

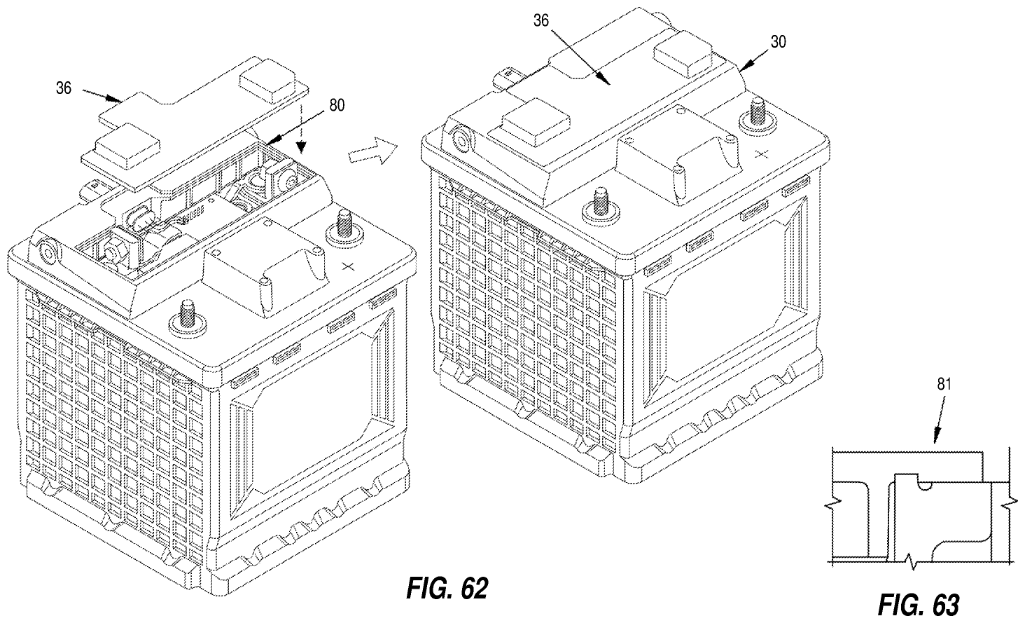

FIGS. 60 and 61 show two views of an example third cover 36, which may be arranged to define or more spaces to receive a terminal and/or protect the terminal 40. FIG. 62 shows the example third cover 36 before and after being coupled to second cover 30 (and/or access opening 80). Third cover 36 (and/or any component of battery 10) may include one or more interfaces 81 show in FIG. 63 such as a laser welding interface and/or third cover 36 may be coupled to second cover 30 using a heating process such as laser welding. In nonlimiting example, laser welding refers to combining (i.e., welding) one or more parts such as combining secondary cover 30 with third cover 36. Other components may also be coupled (i.e., welded) using laser welding. Third cover 36 may be made of any material, e.g., including materials of the first cover 20 and/or second cover 30. For example, for lead acid batteries, third cover 36 may be made of resin, acid resistant polymers such as polypropylene (PP), etc. For non-lead acid batteries, third cover 36 may be made of any thermoplastic and/or thermoset. Although third cover 36 is shown, battery 10 is not limited as such, e.g., battery 10 may comprise a first cover 20 and a second cover 30 (i.e., without a third cover 36 without the corresponding access opening for the third cover 36. Further, communication with a vehicle (or any other system or device) may be established, maintained, and/or terminated using a wireless communication link/protocol, e.g., where a third cover 36 and/or vehicle connector 34 (arranged for wired communication) are not included in battery 10 and without the corresponding access opening in the second cover 30 for the third cover 36.

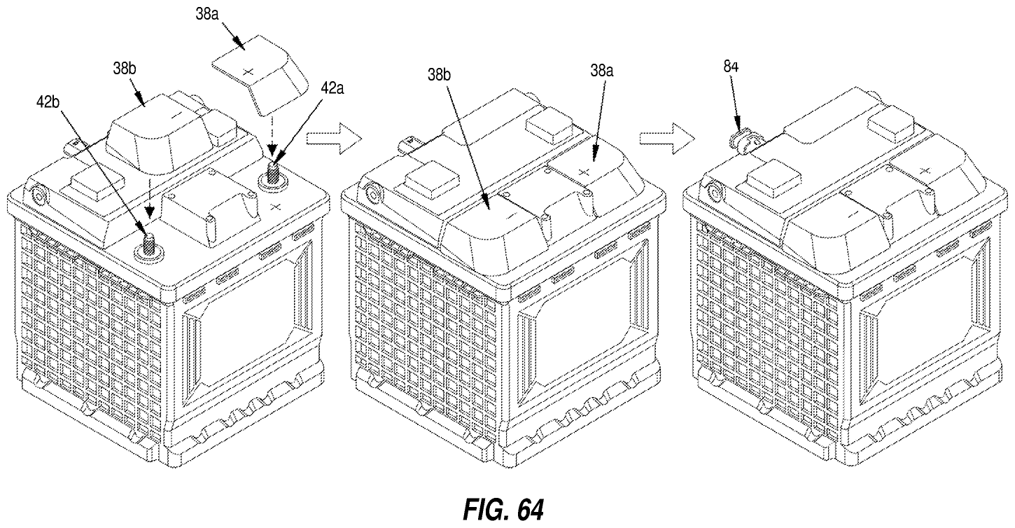

FIG. 64 shows an example terminal cap 38 (e.g., terminal caps 38a, 38b) before and after being coupled to first cover 20 and/or second cover 30 and vehicle connector cap 84 coupled to second cover 30. In other words, assembly steps of terminal caps 38a, 38b and vehicle connector cap 84 are shown. Each terminal cap 38a, 38b may be coupled to first cover 20 and/or second cover 30 and cover a corresponding terminal post 42a, 42b. In this nonlimiting example, terminal post 42a corresponds to a positive terminal, and terminal post 42b corresponds to a negative terminal.

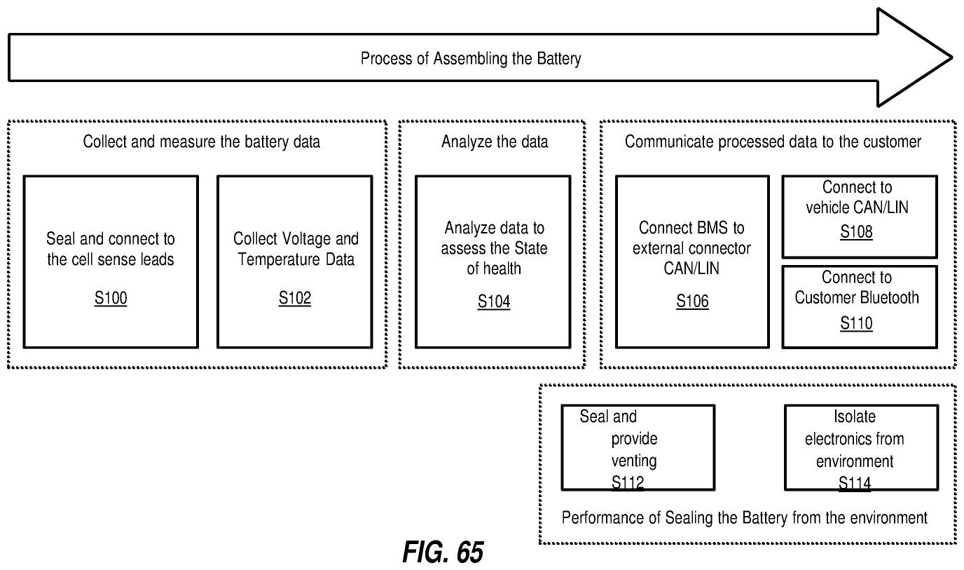

FIG. 65 shows an example process of assembly, manufacturing, and/or operating the battery 10 of one or more embodiments of the present disclosure. At step S100, sealing of one or more components such as covers 20, 30, 36 is performed. Further, a connection of battery cells 14 (e.g., via bushings 22, posts 18, coupling 23, leads 56) to BMS 26 is performed. At step S102, at least one parameter such as voltage and/or temperature data associated with battery cells 14 is collected. Steps S100 and S102 may be part of a battery data collection and measurement process. At step S104, data may be analyzed (e.g., via BMS 26 or any other device in communication with BMS 26 such as via any communication protocol). The data may be associated with the parameters collected at step S102 and may comprise state of health of battery 10 (or any of its components such as battery cells 14). At step S106, BMS 26 may be configured to communicate via an external device and/or connector (e.g., vehicle connector, vehicle, etc.). Communication may include CAN/LIN, Bluetooth, WiFi protocols or any other protocol. At step S108, BMS 26 ma connect to a vehicle using CAN/LIN protocols such as to determine a vehicle parameter, receive a vehicle parameter, determine a parameter of the battery 10, transmit a parameter of the battery 10. Similarly, at step S110, BMS 26 may connect to an external device such as a customer device using Bluetooth. Steps S108 and S110 may be used to communicate process data to a customer. At step S112, battery 10 may be sealed such as by sealing second cover 30 to first cover 20. Venting may be provided via valves 76 and second cover 30. Further, at step S114, electronics such as BMS 26 may be isolated from the environment, e.g., by coupling third cover 36 to second cover 30.

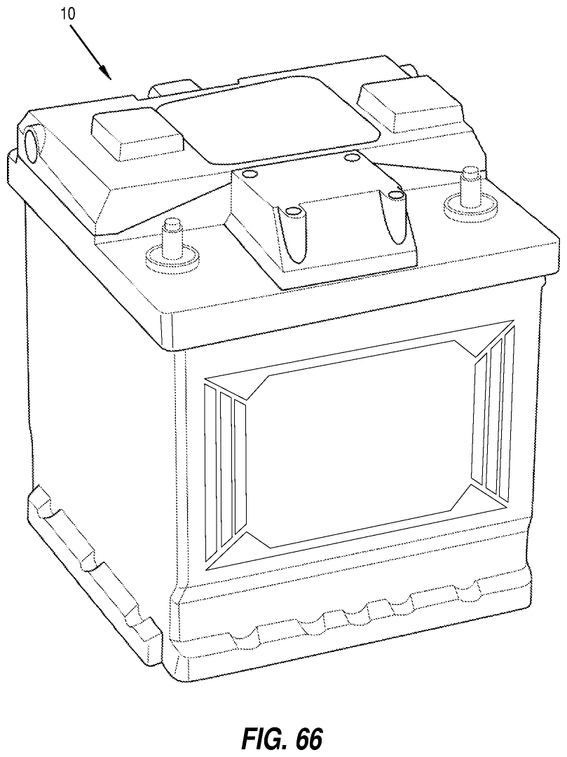

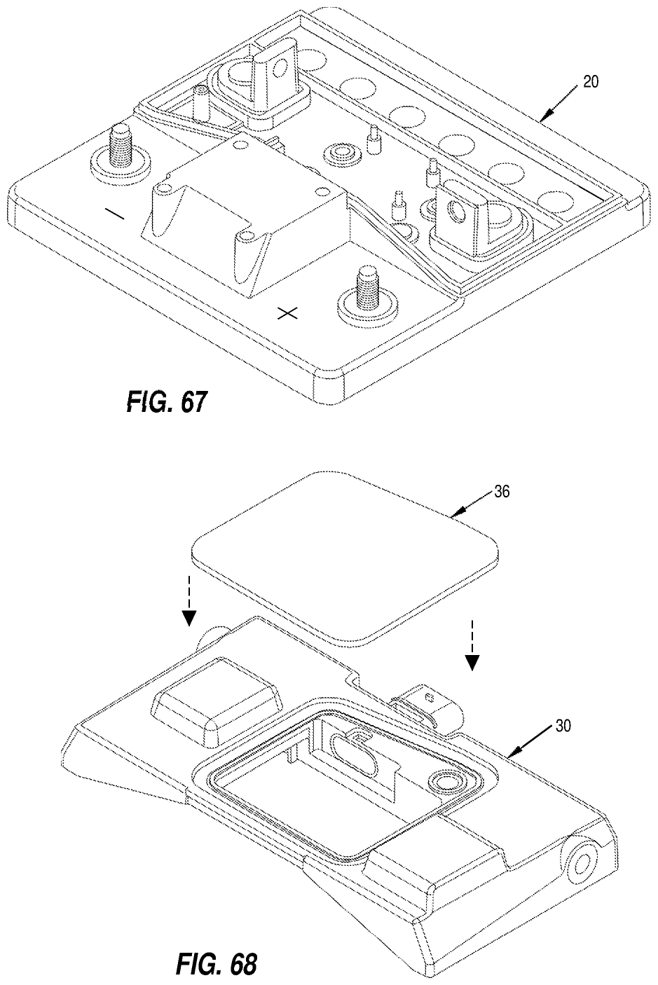

FIGS. 66-76 are directed toward another embodiment of battery 10. However, one or more steps (and/or features) shown in FIGS. 66-76 may be the same as in and/or similar to and/or applicable to FIGS. 1-64. FIG. 66 shows another example battery 10, and FIGS. 67 and 68 show an example first cover 20 and an example second cover 30 and an example third cover 36. The second cover 30 is couplable to the first cover 20, and the third cover 36 is couplable to the second cover 30.

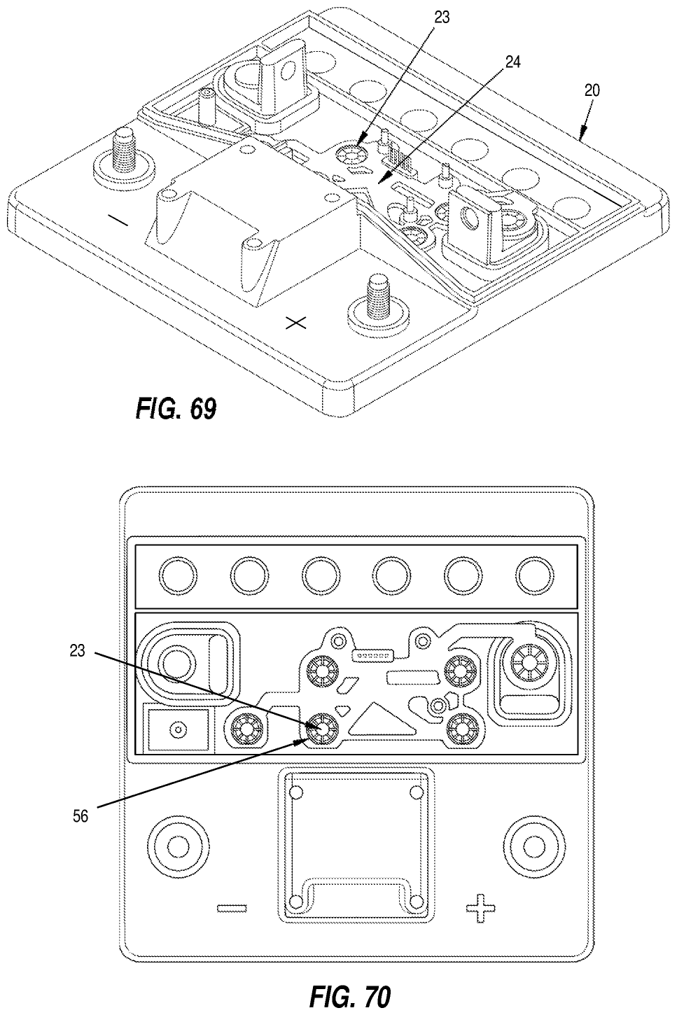

First cover 20 may comprise couplings 23 which may arranged to receive and couple to lead 56 (e.g., sense leads). Couplings 23 may comprise bushings 22 arranged to receive post 18. A corresponding step of an assembly process is shown, which may be a step of the process of FIG. 65. The step may include sealing and/or connecting to leads 56. Posts 18 may be sealed to bushings 22 (e.g., mini-bushings). FIG. 69 shows the example first cover 20 (and corresponding step of the assembly process) and lead assembly 24 where leads 56 are connected to couplings 23 (and/or posts 18 and/or corresponding battery cells 14). FIG. 70 shows the example first cover 20 (and corresponding step of the assembly process) and lead assembly 24. The corresponding step may include placing lead assembly 24 on first cover 20 and/or connecting leads 56 for collecting a battery parameter, e.g., voltage, temperature, data, etc.

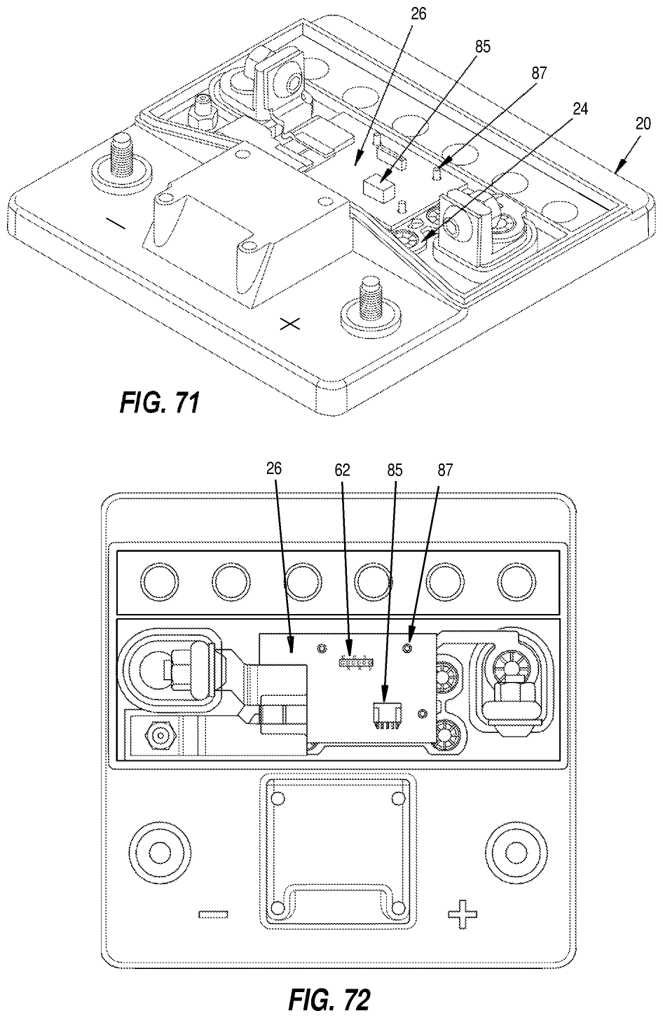

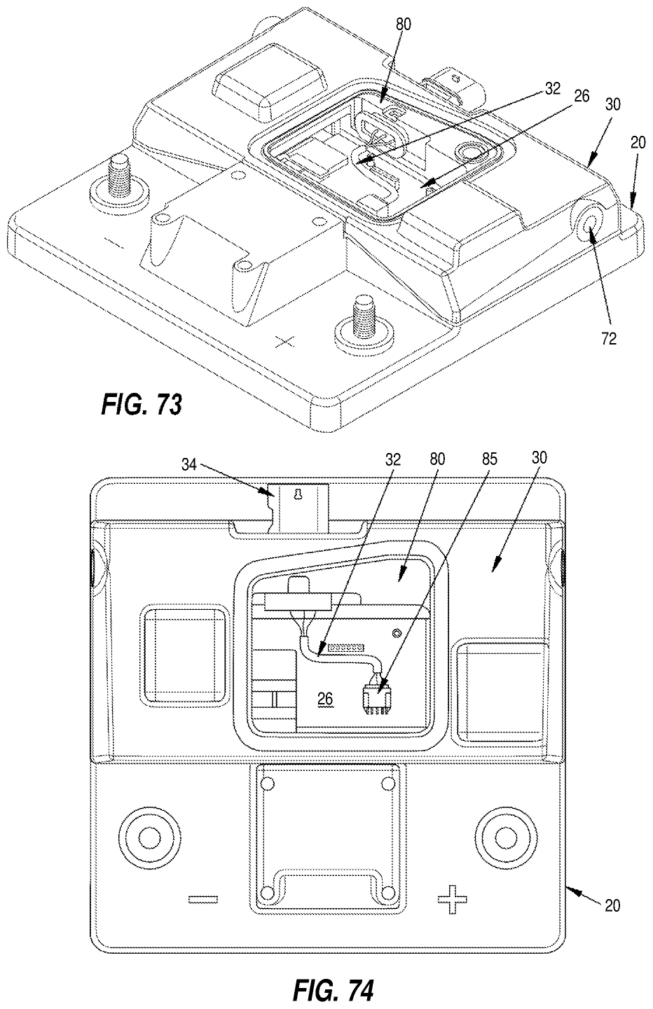

FIGS. 71 and 72 show BMS 26 coupled to the lead assembly 24, where BMS 26 may comprise connector 85 configured to receive one or more conductors for receiving and transmitting signals (e.g., to a vehicle) via vehicle connector 34. BMS 26 may be coupled to the first cover 20 and/or lead assembly 24 via stud 87. FIGS. 73 and 74 show an example second cover 30 coupled to the first cover 20. Second cover 30 has an access opening 80 arranged to provide access to electronic components such as BMS 26, wiring, wiring harness 32 (shown connected to connector 85). Connector 85 may be referred to as or comprised in connector interface 110 of BMS 26.

Further, flame arrestor plug 72 is coupled to second cover 30. Sealing of battery 10 may be performed including sealing second cover 30. Sealing second cover 30 may include sealing vent port 70 by coupling flame arrestor plug to second cover 30 (e.g., to vent port 70) and/or integrate (i.e., couple) valve(s) 76 (i.e., pressure relief valves) and/or flame arrestor(s) 74 to second cover 30. Data may be analyzed, e.g., to access the state of heath of battery 10 and/or its components. BMS 26 may be connected to external connectors, e.g., Controller Area Network (CAN) connectors, Local Interconnect Network (LIN) connectors, vehicle connectors. In some embodiments, flame arrestor 74 can be a separate structure (e.g., not comprised in flame arrestor plug 72) that is coupled to the second cover 30.

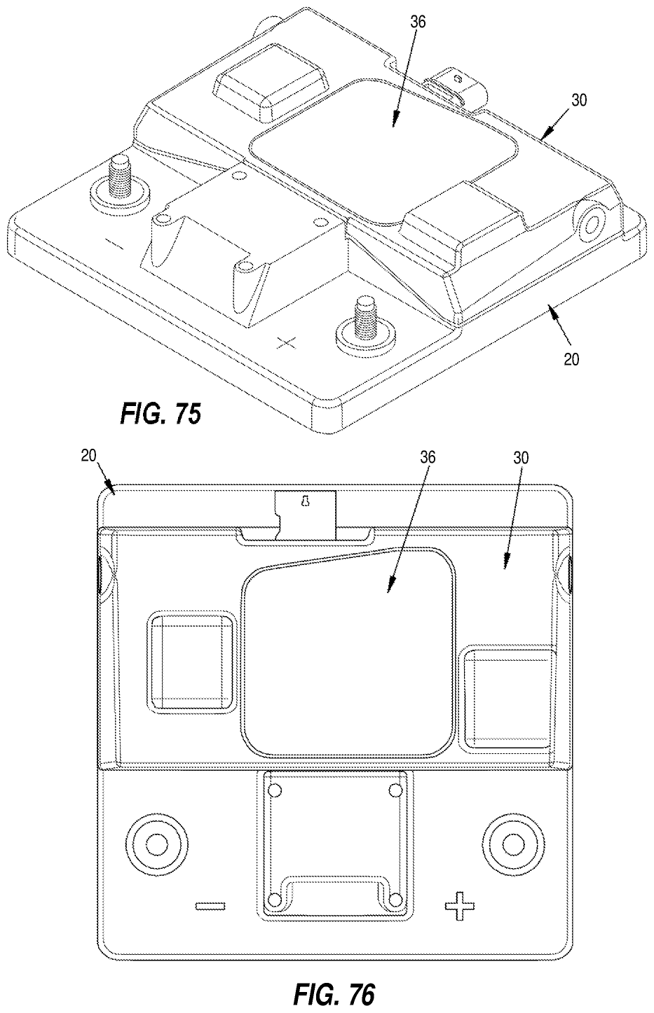

FIGS. 75 and 76 show an example first cover 20 coupled to a second cover 30, and a third cover 36 coupled to the second cover 30, e.g., to isolate (e.g., seal) electronics (e.g., BMS 26) from an environment. Steps of the assembly process may include isolating electronics (e.g., BMS 26) from the environment and/or connecting to a vehicle CAN/LIN and/or connecting another device that may be associated with a customer, e.g., using a protocol such as Bluetooth. Although third cover 36 is shown, battery 10 is not limited as such, e.g., battery 10 may comprise a first cover 20 and a second cover 30 (i.e., without a third cover 36 and corresponding access opening in the second cover 30). Further, communication with vehicle (or any other system or device) may be established, maintained, and/or terminated using a wireless communication link/protocol, e.g., where a third cover 36 and/or vehicle connector 34 (arranged for wired communication) are not included in battery 10.

FIG. 77 shows an example BMS 26. BMS 26 may include at least one of processing circuitry 100, processor 102, memory 106, battery state unit 108, and connector interface 110. Processing circuitry 100, which may have storage and/or processing capabilities. The processing circuitry 100 may include processor 102 and memory 106. In particular, in addition to or instead of a processor, such as a central processing unit, and memory, the processing circuitry 100 may comprise integrated circuitry for processing and/or control, e.g., one or more processors and/or processor cores and/or FPGAs (Field Programmable Gate Array) and/or ASICs (Application Specific Integrated Circuitry) adapted to execute instructions. The processor 102 may be configured to access (e.g., write to and/or read from) memory 106, which may comprise any kind of volatile and/or nonvolatile memory, e.g., cache and/or buffer memory and/or RAM (Random Access Memory) and/or ROM (Read-Only Memory) and/or optical memory and/or EPROM (Erasable Programmable Read-Only Memory).

Processing circuitry 100 may be configured to control any of the methods and/or processes described herein and/or to cause such methods, and/or processes to be performed, e.g., by BMS 26 and/or battery 10. Processor 102 corresponds to one or more processors 102 for performing battery 10 functions described herein. Memory 106 may be configured to store data, programmatic software code and/or other information described herein. In some embodiments, software may include instructions that, when executed by the processor 102 and/or processing circuitry 100, causes the processor 102 and/or processing circuitry 100 to perform the processes described herein. The instructions may be software associated with BMS 26 and/or battery 10. Further, battery state unit 108 may be configured to perform any of the steps and/or methods and/or functions and/or processes and/or features of the present disclosure, e.g., by BMS 26 and/or battery 10. Connector interface 110 may be any interface arranged/configured to connect to (and/or communicate with) any other device and/or component of battery 10 such as any lead 56 and/or vehicle connector 34 and/or wiring harness 32 and/or any device by wireless/wired communication, e.g., using any communication protocol. Connector interface 110 may be in communication with any of the components of battery 10, such as processing circuitry 100, processor 102, memory 106, and/or battery state unit 108.

In a nonlimiting example, BMS 26 is configured to determine (i.e., capture, measure, read, etc.) data including battery cell data and/or battery cell parameters, e.g., via processing circuitry 100 and/or connector interface 110 and/or lead 56 of lead assembly 24 and/or post 18 and/or bushing 22 and/or battery cells 14. More specifically, BMS 26 may be configured to determine a state of health of a battery cell 14 and/or battery 10 by using a connection that is established between BMS 26 and the battery cell 14 via leads 56 and post 18 and battery cells 14. Further, BMS 26 may be further configured to analyze the data. BMS 26 may also be configured to communicate the analyzed data or any other data, e.g., transmit/receive data which may include battery cell data and/or battery cell parameters, e.g., via wiring harness 32 and/or vehicle connector 34 and/or connector interface 110. The analyzed data or any other data may be transmitted to and/or received from another device, e.g., that may be connected to BMS 26 such as via vehicle connector 34 and/or connector interface 110. Communicating data may be performed using a protocol such as CAN and/or LIN via vehicle connector 34 to a vehicle and/or Bluetooth via connector interface 110 to a customer. That is, communicating data is not limited to wired connections/protocols and may also include the use of any wireless connections/protocols to communicate to one or more devices/systems. The arrangement described above is beneficial at least because battery 10 is capable of capture data such as battery cell data (e.g., lead acid battery cell data) and/or process the data and/or communicate the data for monitoring and/failure prediction of battery cells and other battery components.

The following is a non-limiting example set of parameters for a battery 10 that may be constructed in accordance with the principles of the present disclosure.

EXAMPLE PARAMETER TABLE

| | |
|---|---|
| Capacity | 40-100 Ah* |
| Voltage Range | 6.5-16 V |
| EN CCA | 420-900A* |
| Operation | −40 to 60° C.; 85° C. for short duration peaks |
| Temp Range | |
| Storage Temp Range | −40 to 75° C. |
| Functional Safety | ASIL B |
| Calendar Life | Similar to AGM Standard |
| Weight | 12-31 Kg * |
| L × W × H mm | Follows EN50342-2 (e.g. H3: 175 × 175 × 190) |
| Communication | CAN/LIN/Wireless |
| Terminal | M8 Threaded |

*= Depends on Battery Group Size

It is noted that some embodiments of the battery 10 described herein may offer an alternative to the use of 12V Li-Ion for electric vehicle applications, including functional safety capability and the benefits inherent in AGM battery technologies, including but not limited to lower cost, better safety and more sustainable production than Li-Ion batteries. As discussed above, embodiments of battery 10 may include cell-level monitoring, on-board wired/wireless communications, e.g., for battery management, and may have the same footprint as existing AGM batteries. For example, battery 10 may be made in various battery group sizes, including but not limited to H3, H4, H5, H6 and Grp31.

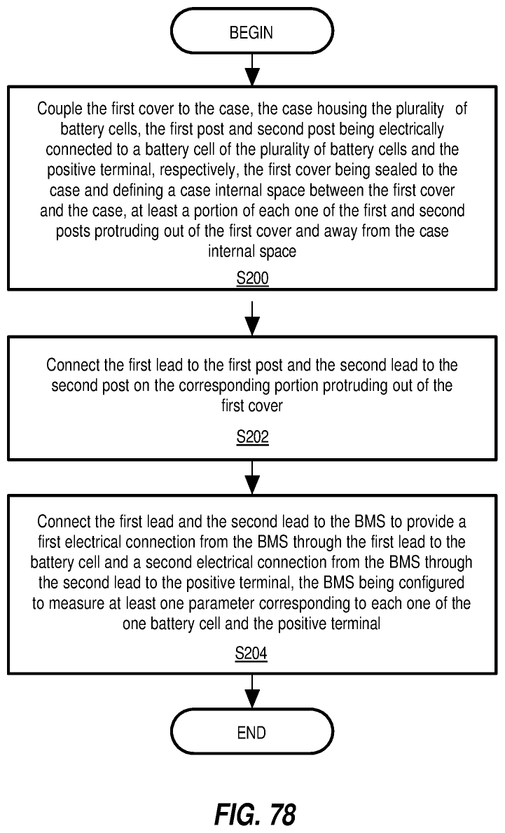

FIG. 78 shows an example assembly method of a battery 10. Battery 10 comprising a case 12, a plurality of battery cells 14, a first post 18a and a second post 18b, a first cover 20, a positive terminal 40, a lead assembly 24 including a first lead 56a and a second lead 56b, and a battery management system (BMS) 26. The method includes coupling (Block S200) the first cover 20 to the case 12, the case 12 housing the plurality of battery cells 14. The first post 18a and second posts 18b are electrically connected to a battery cell of the plurality of battery cells 14 and the positive terminal, respectively. The first cover 20 is sealed to the case 12 and defines a case internal space 13 between the first cover 20 and the case 12. At least a portion of each one of the first and second posts 18a, 18b protrude out of the first cover 20 and away from the case internal space 13. The method further includes connecting (Block S202) the first lead 56a to the first post 18a and the second lead 56b to the second post 18b on the corresponding portion protruding out of the first cover 20. The method also includes connecting (Block S204) the first lead 56a and the second lead 56b to the BMS 26 to provide a first electrical connection from the BMS 26 through the first lead 56a to the battery cell 14 and a second electrical connection from the BMS 26 through the second lead 56b to the positive terminal. The BMS is configured to measure, e.g., via processing circuitry 100 and/or connector interface 110, at least one parameter corresponding to each one of the one battery cell and the positive terminal. Measuring may refer to determining.

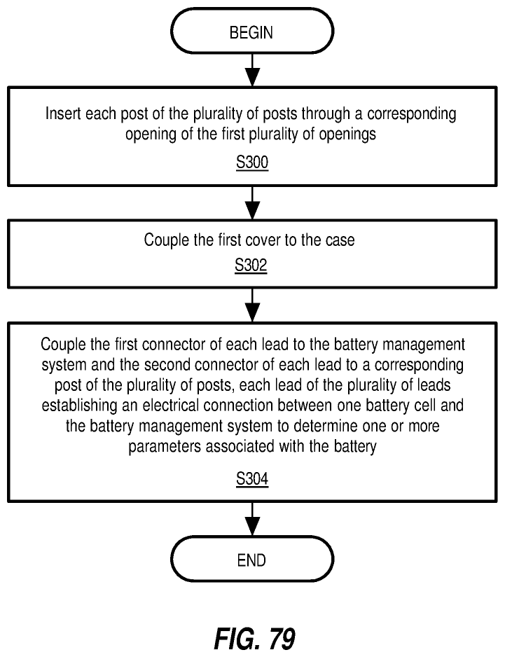

FIG. 79 shows another example assembly method of a battery 10. The battery 10 comprises a plurality of posts 18, a plurality of battery cells 14, a case 12, a first cover 20, a battery management system 26, and a lead assembly 24. Each battery cell of the plurality of battery cells 14 is coupled to one post of the plurality of posts 18. The case houses the plurality of battery cells 14. The first cover 20 comprises a first plurality of openings 44. The lead assembly 24 comprises a plurality of leads 56. Each lead 56 comprises a first connector 62 and a second connector 58, 60. The method comprises inserting each post 18 of the plurality of posts 18 through a corresponding opening 44 of the first plurality of openings 44; coupling the first cover 20 to the case 12; and coupling the first connector 62 of each lead 56 to the battery management system 26 and the second connector 58, 60 of each lead 56 to a corresponding post 18 of the plurality of posts 18. Each lead 56 of the plurality of leads 56 establishes an electrical connection between one battery cell 14 and the battery management system 26 to determine one or more parameters associated with the battery 10.

In some embodiments, the first cover 20 further comprises a plurality of bushings 22, and the method further comprises coupling each bushing 22 of the plurality of bushings 22 to a corresponding opening 44 of the first plurality of openings 44. The inserting of each post 18 of the plurality of posts 18 through the corresponding opening 44 comprises inserting each post 18 of the plurality of posts 18 through a corresponding bushing 22; and coupling each posts 18 of the plurality of posts 18 to the corresponding bushing 22.

In some other embodiments, the inserting of each post 18 of the plurality of posts 18 through the corresponding opening 44 and coupling the first cover 20 to the case 12 create a case internal space 13 defined by the first cover 20, the case 12, each bushing 22, and each post 18. The coupling of the second connector 58, 60 of each lead 56 to the corresponding post 18 is external to the case internal space 13.

In an embodiment, the first cover 20 further comprises a second plurality of openings 46 and a second cover 30. The second cover comprises a cover space 68. The method comprises coupling the second cover 30 to the first cover 20, the coupling of the second cover 30 establishing fluid communication between the cover space 68 and the case internal space 13 through the second plurality of openings 46.

In another embodiment, the second cover 30 comprises a valve 76 and a flame arrestor plug 72, and the method comprises coupling the valve 76 to the second cover 30, where the valve 76 is in fluid communication with the cover space 68; and coupling the flame arrestor plug 72 to the second cover 30. The flame arrestor plug 72 is in fluid communication with the valve 76.

In some embodiments, the second cover 30 further comprises a vehicle connector 34, and the method further comprises electrically coupling the vehicle connector 34 to the battery management system 26.

In some other embodiments, the battery 10 further comprises a third cover 36, the second cover 30 comprises an access opening 80, and the method further comprises coupling the third cover 36 the second cover 30 to cover the access opening 80. The first, second, and third covers 20, 30, 36 define an access space, where the access space is external to the cover space 68 and comprises the battery management system 26 and the lead assembly 24.

In an embodiment, the battery 10 comprises a first terminal 40a and a second terminal 40b, and the method further comprises coupling the first terminal 40 to the first connector of one lead 56 of the plurality of leads 56; and coupling the second terminal to the battery management system 26.

The following is a nonlimiting list of example embodiments:
1. A method for assembling a battery 10, the battery 10 comprising a case 12, a plurality of battery cells 14, a first post 18a and a second post 18b, a first cover 20, a positive terminal, a lead assembly 24 including a first lead 56a and a second lead 56b, and a battery management system, BMS 26, the method comprising:
coupling the first cover 20 to the case 12, the case 12 housing the plurality of battery cells 14, the first post 18a and second post 18b being electrically connected to a battery cell of the plurality of battery cells 14 and the positive terminal, respectively, the first cover 20 being sealed to the case 12 and defining a case internal space 13 between the cover and the case 12, at least a portion of each one of the first and second posts 18a, 18b protruding out of the first cover 20 and away from the case internal space 13;
connecting the first lead 56a to the first post 18a and the second lead 56b to the second post 18b on the corresponding portion protruding out of the first cover 20; and
connecting the first lead 56a and the second lead 56b to the BMS 26 to provide a first electrical connection from the BMS 26 through the first lead 56a to the battery cell 14 and a second electrical connection from the BMS 26 through the second lead 56b to the positive terminal, the BMS 26 being configured to measure at least one parameter corresponding to each one of the one battery cell 14 and the positive terminal.
2. The method of Embodiment 1, wherein the method further includes:
inserting the plurality of cells in the case 12; and
connecting the first post 18a and second post 18b to the battery cell of the plurality of battery cells 14 and the positive terminal, respectively.
3. The method of any one of Embodiments 1 and 2, wherein the first cover 20 includes at least a first cover opening and a second cover opening, and placing the cover on the case 12 includes inserting the first post 18a and the second post 18b through the first cover opening and the second cover opening, respectively.
4. The method of Embodiment 3, wherein inserting the first post 18a and the second post 18b includes placing a bushing 22 on each one of the first and second posts 18a, 18b.
5. The method of any one of Embodiments 1-4, wherein in the first and second leads are comprised in a lead assembly, and the method includes:
coupling the lead assembly 24 to the first cover 20; and
heating the first and second leads to connect the first lead 56a to the first post 18a and the second lead 56b to the second post 18b on the corresponding portion protruding out of the first cover 20.
6. The method of any one of Embodiments 1-5, wherein the method further includes:
coupling the BMS 26 to the first cover 20.
7. The method of any one of Embodiments 1-6, wherein the first cover 20 includes at least one vent opening, the battery 10 further includes a second cover 30, and the method further includes:
coupling the second cover 30 to the first cover 20, the coupled second cover 30 defining a cover space in fluid communication with the case internal space 13 through the at least one vent opening, the second cover 30 further including at least one vent port and at least one valve, the at least one valve being in fluid communication with the cover space 68.
8. The method of Embodiment 7, wherein the at least one valve is arranged to open when a pressure within the cover space exceeds a predetermined threshold.
9. The method of any one of Embodiments 1-8, wherein the battery 10 further includes a third cover 36, and the second cover 30 includes an access opening, the method further including:
coupling the third cover 36 to the access opening of the second cover 30.
10. The method of any one of Embodiments 1-9, wherein the battery 10 is a lead acid battery 10.
11. A battery 10 comprising:
a case 12;
a plurality of battery cells 14 within the case 12;
a first post 18a, a second post 18b, a third post 18c, each one of the first, second, and third post being electrically connected to a corresponding battery cell of the plurality of battery cells 14;
a first cover 20 being sealed to the case 12 and defining a case internal space between the cover and the case 12, the first cover 20 having at least a first cover opening, a second cover opening, and a third cover 36 opening, the first, second, and third cover 36 openings being arranged to receive the first, second, and third posts, respectively, at least a portion of each one of the first, second, and third posts protruding out of the first cover 20 and away from the case internal space;
a lead assembly 24 having at least a first lead 56a and a second lead 56b, each one of the first and second leads having a post connector and a battery management system, BMS 26, connector, the post connector of each one of the first and second leads being electrically connected to the first and second posts 18a, 18b, respectively;
a BMS 26 including a board, the board having a first board opening and a second board opening, the BMS connector of each one of the first and second leads protruding through the first and second board openings and being electrically connected to the BMS 26, the BMS 26 being electrically connected to the third post and comprising processing circuitry, the processing circuitry being electrically connected to the BMS connector of each one of the first and second leads and being configured to measure at least one parameter of at least one cell of the plurality of cells.
12. The battery 10 of Embodiment 11, wherein at least one of the first, second, and third posts are covered with a bushing 22 at least to further seal the first cover 20 to the case 12.
13. The battery 10 of any one of Embodiments 11 and 12, wherein the battery 10 further includes a positive terminal and a negative terminal, the first post 18a being a battery cell post, the second post 18b being electrically connected to the positive terminal, and the third post is electrically connected to the negative terminal.
14. The battery 10 of any one of Embodiments 11-13, wherein the first cover 20 includes at least one vent opening, and the battery 10 further includes a second cover 30 sealed to the first cover 20 and defining a cover space in fluid communication with the case internal space, the second cover 30 including at least one vent port and at least one valve in fluid communication with the cover space.
15. The battery 10 of Embodiment 14, wherein the at least one valve is arranged to open when a pressure within the cover space exceeds a predetermined threshold.
16. The battery 10 of any one of Embodiments 11-15, wherein the battery 10 further includes a third cover 36, and the second cover 30 includes an access opening arranged to receive the third cover 36 and seal the second cover 30 to the third cover 36.
17. A battery 10 comprising:
a plurality of battery cells 14;
a first post 18a and a second post 18b, each one of the first and second post 18b being electrically connected to a first battery cell and a second battery cell of the plurality of battery cells 14, respectively;
a lead assembly 24 having at least a first lead 56a and a second lead 56b, each one of the first and second leads having a post connector and a battery management system, BMS 26, connector, the post connector of each one of the first and second leads being electrically connected to the first and second battery cells 14, respectively; and
a BMS 26 including a circuit board, the circuit board having a first board opening and a second board opening, the BMS connector of each one of the first and second leads protruding through the first and second board openings and being electrically connected to the BMS 26, the BMS 26 comprising processing circuitry, the processing circuitry being electrically connected to the BMS connector of each one of the first and second leads and being configured to measure at least one parameter of the first and second battery cells 14 and/or transmit the measured at least one parameter.
18. The battery 10 of Embodiment 17, wherein the battery 10 further includes a case 12 housing the plurality of battery cells 14, a first cover 20 sealed to the case 12 having at least a first cover 20 opening and a second cover opening, the first and second cover openings being arranged to receive the first and second posts 18a, 18b, respectively.
19. The battery 10 of any one of Embodiments 17 and 18, wherein the battery 10 further includes a positive terminal, the second battery cell includes a positive electrode corresponding to the positive terminal, and the second post 18b is connected to the positive electrode.
20. The battery 10 of any one of Embodiments 17-19, wherein the at least one parameter includes a battery cell voltage.
21. The battery 10 of any one of Embodiments 17-20, wherein at least one of:
at least one of the battery cells 14 of the plurality of battery cells 14 is a lead acid battery cell; and
the battery 10 is a lead acid battery 10.
22. The battery 10 of any one of Embodiments 17-21, wherein at least one of:
at least one of the battery cells 14 of the plurality of battery cells 14 is an absorbent glass mat, AGM, battery cell; and
the battery 10 is an AGM lead acid battery 10.

Further, in some embodiments, a lead-acid battery module is described. The led-acid battery module may refer to one or more components of battery 10 such as first cover 20, second cover 30, third cover 36, BMS 26, lead assembly 24, bushings 22, posts 18, etc. The lead-acid battery module includes a housing (i.e., case 12) defining at least in part a cells compartment. The housing further defines, at least in part, a battery monitoring system (BMS) compartment, and includes a wall disposed between the cells compartment and the BMS compartment. A battery cell 14 is housed in the cells compartment, and the battery cell 14 has a first post 18a and a second post 18b associated with the battery cell. The first post 18a and the second post 18b protrude through the wall from the cells compartment to the BMS compartment. A battery monitor system (BMS) 26 is housed by the BMS compartment. The BMS includes a parameter sensor (e.g., voltage sensor) electrically coupled to the first post 18a and the second post 18b.

The following is another nonlimiting list of example embodiments:
1. A battery module (e.g., of a battery 10) comprising:
   a cells compartment (e.g., at least a portion of case internal space 13);
   a battery monitoring system compartment (e.g., defined by first cover 20, second cover 30, and third cover 36) and;
   a wall (e.g., cell separator 15) positioned between the cells compartment and the battery monitoring system compartment; and
   posts 18 extending through the wall between the cells compartment and the battery monitoring system compartment.
2. The battery module of claim 1, wherein a base of the cells compartment has a footprint of an H3 battery.
3. The battery module of claim 1 or 2, further comprising:
   a plurality of battery cells 14 housed by the cells compartment; and
   a plurality of battery straps 17 electrically connecting the plurality of battery cells 14.
4. The battery module of claim 3, wherein one of the plurality of battery straps 17 includes a terminal post 18.
5. The battery module of claim 3 or 4, wherein one of the plurality of battery straps 17 includes a strap post 17.
6. The battery module of one of claims 3-5, wherein one of the plurality of battery straps includes a base portion and an orthogonal portion (e.g., strap end 19).
7. The battery module of one of claims 3-6, wherein one of the plurality of battery straps includes a base portion and a ramp portion.
8. The battery module of one of claims 4-7, wherein the battery monitoring system compartment comprises a battery monitoring system (BMS) 26 having a spider-leg connector electrically connecting the strap post 18 to a circuit board 64.
9. The battery module of claim 8, wherein the BMS 26 further comprises a first bus bar electrically connecting the terminal post 18 to the circuit board 64 and a second bus bar coupling the circuit board 64 to a terminal of the battery module.
10. The battery module of claim 9, wherein the bus bars are multi-planer bus bars.
11. A vehicle comprising the battery module of one of claims 1-10.

It will be appreciated by persons skilled in the art that the present embodiments may be not limited to what may have been particularly shown and described. In addition, unless mention was made above to the contrary, it should be noted that all of the accompanying drawings may be not to scale. A variety of modifications and variations may be possible in light of the above teachings and following claims.

1. A lead assembly of a battery comprising a plurality of battery cells, the lead assembly comprising:
a plurality of leads, each lead having a first end, a second end opposite to the first end, the first end comprising a first connector, the second end comprising a second connector, the second connector of one or more leads being couplable to a corresponding battery cell of the plurality of battery cells; and
a lead frame enclosing at least a portion of each of the leads of the plurality of leads.

2. The lead assembly of claim 1, wherein the second connector comprises a lead ring.

3. The lead assembly of claim 2, wherein the second connector further comprises a post connector coupled to the lead ring, the post connector being couplable to one battery cell.

4. The lead assembly of claim 1, wherein the plurality of leads comprises one lead couplable to a terminal, the lead frame comprises a first portion, a second portion, and an adjustable arm coupled to the first and second portions, the first portion comprising the one lead.

5. The lead assembly of claim 4, wherein the adjustable arm is arranged to adjust a position of the first portion, the adjusted position causing the first portion and the second portion to be in different planes.

6. The lead assembly of claim 1, wherein the first end of each lead protrudes from the lead frame and is couplable to a battery management system.

7. A battery, the battery comprising:
a plurality of posts;
a plurality of battery cells, each battery cell of the plurality of battery cells being coupled to one post of the plurality of posts;
a case housing the plurality of battery cells;
a first cover sealed to the case and comprising a first plurality of openings, each opening of the first plurality of openings receiving one post of the plurality of posts and coupling the one post to the first cover;
a battery management system configured to determine one or more parameters associated with the battery; and
a lead assembly comprising a plurality of leads, each lead of the plurality of leads having a first end, a second end opposite to the first end, the first end comprising a first connector, the second end comprising a second connector, the first connector of each lead being coupled to the battery management system, the second connector of each lead being coupled to one post, each lead of the plurality of leads establishing an electrical connection between one battery cell and the battery management system to determine the one or more parameters.

8. The battery of claim 7, wherein the battery further comprises:
a plurality of straps, each strap of the plurality of straps having a first side and a second side, the first side being coupled to one post of the plurality of posts, the second side being coupled to one battery cell of the plurality of battery cells.

9. The battery of claim 7, wherein the first cover further comprises:
a plurality of bushings, each bushing of the plurality of bushings being coupled to the first cover and one corresponding post.

10. The battery of claim 9, wherein the battery further comprises a case internal space defined by the first cover, the case, and the coupling of each bushing to the first cover and to the one corresponding post.

11. The battery of claim 10, wherein the coupling of the second connector further comprises:
coupling the second connector to one corresponding bushing, the coupling of the second connector being external to the case internal space.

12. The battery of claim 10, wherein the battery further comprises a second cover sealed to the first cover and defining a cover space between the first and second covers, the first cover further comprising a second plurality of openings establishing fluid communication between the cover space and the case internal space, wherein the second cover comprises a valve arranged to release, from the case internal space and the cover space, fluid having a pressure at or greater than a predetermined pressure threshold.

13. (canceled)

14. The battery of claim 12, wherein the second cover further comprises a flame arrestor plug in fluid communication with the valve, the flame arrestor plug comprising a flame arrestor arranged to prevent a flame ignitable by the release of fluid by the valve.

15. The battery of claim 12, wherein the battery further comprises a third cover, the second cover including an access opening and being coupled to the third cover to cover the access opening, the first, second, and third covers defining an access space, the access space being external to the cover space and comprising the battery management system and the lead assembly.

16. The battery of claim 7, wherein the lead assembly further comprises a lead frame enclosing at least a portion of each of the leads of the plurality of leads.

17. The battery of claim 16, wherein the lead frame comprises a first portion, a second portion, and an adjustable arm coupled to the first and second portions.

18. The battery of claim 17, wherein the adjustable arm is arranged to adjust a position of the first portion, the adjusted position causing the first portion and the second portion to be in different planes.

19. The battery of claim 18, wherein the battery comprises a first terminal, the first portion being coupled to the first terminal and further establishing the electrical connection between the first terminal and the battery management system.

20. (canceled)

21. The battery of claim 7, wherein the plurality of battery cells includes a first cell and a second cell, and the one of more parameters determined by the battery management system includes one or both of:
a first voltage of the first cell and a second voltage of the second cell; and
a first temperature of the first cell and a second temperature of the second cell, the first voltage, the second voltage, the first temperature, and the second temperature being determined using the established electrical connection.

22. The battery of claim 7, wherein the battery management system is further configured to one or more of:
receive a vehicle parameter;
determine the vehicle parameter based on the one or more parameters associated with the battery;
cause transmission of the determined vehicle parameter; and
cause transmission of the one or more parameters associated with the battery.

23.-30. (canceled)
